(19) United States
(12) Patent Application Publication
(10) Pub. No.: US 2026/0339751 A1
(43) Pub. Date: Oct. 29, 2026

(54) WORKLOAD AGGREGATION SYSTEM AND NON-TRANSITORY COMPUTER-READABLE RECORDING MEDIUM

(71) Applicant: 1FINITY Inc., Kawasaki-shi (JP)

(72) Inventor: Eitatsu YOSHIDA, Fukuoka (JP)

(73) Assignee: 1FINITY Inc., Kawasaki-shi (JP)

(21) Appl. No.: 19/576,870

(22) Filed: Mar. 24, 2026

(30) Foreign Application Priority Data
Apr. 25, 2025 (JP) 2025-073683

(51) Int. Cl. G06F 9/50

(52) U.S. Cl. CPC G06F 9/5083

(57) ABSTRACT

A workload aggregation system includes information processing apparatuses and accelerators. The accelerators are used for processing workloads received by their connection-destination information processing apparatuses. The first and second information processing apparatuses are connected to first and second accelerators, respectively. A control apparatus detects that workloads processed by the first and second information processing apparatuses are aggregatable into one information processing apparatus, based on the processor loads of the information processing apparatuses, prepares a third information processing apparatus to which an accelerator different from the first and second accelerators is connected, changes the transmission destination of these workloads to the third information processing apparatus, powers off the first and second information processing apparatuses, changes the connection destination of the second accelerator to the first information processing apparatus, powers on the first information processing apparatus, and changes the transmission destination of these workloads to the first information processing apparatus.

### CROSS-REFERENCE TO RELATED APPLICATION

This application is based upon and claims the benefit of priority of the prior Japanese Patent Application No. 2025-073683, filed on Apr.25, 2025, the entire contents of which are incorporated herein by reference.

### FIELD

The embodiments discussed herein relate to a workload aggregation system and a non-transitory computer-readable recording medium.

### BACKGROUND

There is a system in which a plurality of server apparatuses and a plurality of accelerators such as graphics processing units (GPUs) are connected via a connection device such as a fabric switch. In this system, when a server apparatus is stopped, the number of accelerators allocated to the server apparatus is changed by reallocating the accelerators allocated to the server apparatus via the connection device and by activating the server apparatus. The system performs this change, without an operation such as slot insertion and removal. The individual server apparatus is able to offload part of its processing to its accelerator.

There has been proposed an operating system that implements an application execution engine called a custom execution environment by using one or more partitions of the system resources of a computer system. The custom execution environment includes a service for resuming or restarting the processing of an application in the event of a system error.

International Publication Pamphlet No. WO 2004/079547

### SUMMARY

In one aspect, there is provided a workload aggregation system including: a plurality of information processing apparatuses, each of which has a processor; a plurality of accelerators which are connectable to the plurality of information processing apparatuses and are used for processing a workload received by a connection destination information processing apparatus; and a control apparatus which detects that a plurality of workloads processed by a first information processing apparatus and a second information processing apparatus among the plurality of information processing apparatuses, the first information processing apparatus being connected to a first accelerator among the plurality of accelerators, and the second information processing apparatus being connected to a second accelerator among the plurality of accelerators, are aggregatable into one information processing apparatus, based on a load of the processor of each of the plurality of information processing apparatuses, prepares a third information processing apparatus to which an accelerator different from the first accelerator and the second accelerator among the plurality of accelerators is connected, changes the transmission destination of the plurality of workloads to the third information processing apparatus, powers off the first information processing apparatus and the second information processing apparatus, changes the connection destination of the second accelerator to the first information processing apparatus, powers on the first information processing apparatus, and changes the transmission destination of the plurality of workloads to the first information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a workload aggregation system according to a first embodiment;

FIG. 2 is a diagram illustrating a processing example of the workload aggregation system;

FIG. 3 is a diagram illustrating a processing example of the workload aggregation system;

FIG. 4 is a diagram illustrating an example of an information processing system according to a second embodiment;

FIG. 5 is a diagram illustrating a hardware example of an allocation server;

FIG. 6 is a diagram illustrating a hardware example of a device pool coordination system;

FIG. 7 is a diagram illustrating a functional example of the information processing system;

FIG. 8 is a diagram illustrating an example of a server status table;

FIG. 9 is a flowchart illustrating an example of workload aggregation processing;

FIG. 10 is a diagram illustrating an example of workload allocation;

FIG. 11 is a diagram illustrating an example of the loads of calculation servers;

FIG. 12 is a diagram illustrating an example of the loads of the calculation servers;

FIG. 13 is a diagram illustrating an example of preparation of an offload server;

FIG. 14 is a diagram illustrating an example of registration of the offload server in the server status table;

FIG. 15 is a diagram illustrating an example of offloading workloads to the offload server;

FIG. 16 is a diagram illustrating an example of the server status table obtained after the workloads are offloaded;

FIG. 17 is a diagram illustrating an example of power-off of calculation servers;

FIG. 18 is a diagram illustrating an example of the server status table obtained after the calculation servers are powered off;

FIG. 19 is a diagram illustrating an example in which a GPU is added to a calculation server and the calculation server is powered on;

FIG. 20 is a diagram illustrating an example of the server status table obtained after the calculation server is powered on;

FIG. 21 is a diagram illustrating an example in which workloads are switched to a calculation server;

FIG. 22 is a diagram illustrating an example of the server status table obtained after the workloads are switched;

FIG. 23 is a diagram illustrating an example in which an offload server is powered off;

FIG. 24 is a diagram illustrating an example of the server status table obtained after the offload server is powered off; and

FIG. 25 is a diagram illustrating an example of a workload management table.

### DESCRIPTION OF EMBODIMENTS

Stopping server apparatuses in order to reallocate accelerators among these server apparatuses causes a problem in that the processing being executed by these server apparatuses is interrupted.

Hereinafter, embodiments will be described with reference to the drawings.

### First Embodiment

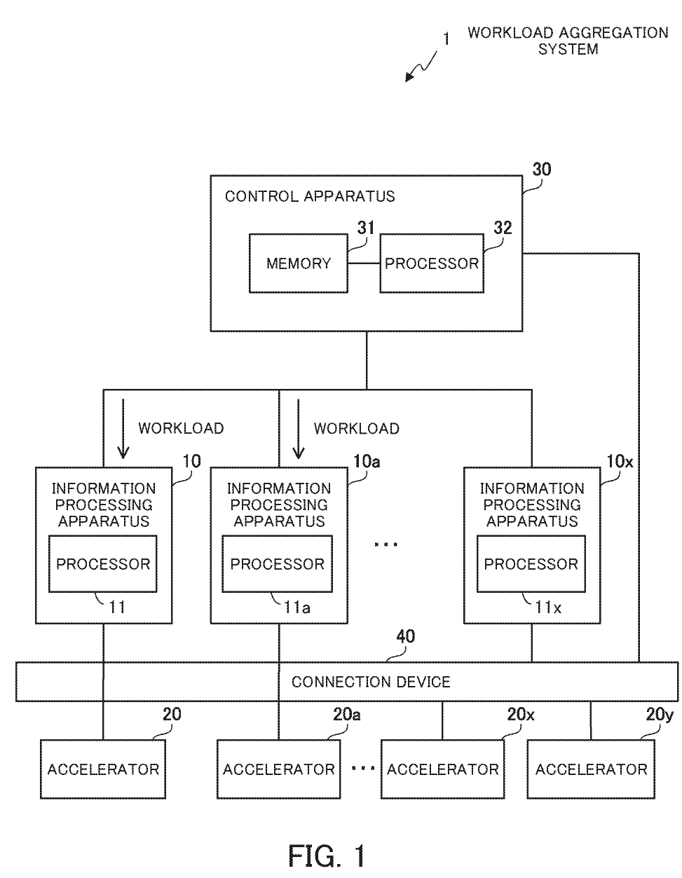

FIG. 1 is a diagram illustrating a workload aggregation system according to a first embodiment. This workload aggregation system 1 processes a plurality of workloads, using a plurality of information processing apparatuses. A workload is data used for certain processing. For example, an information processing apparatus performs inference processing based on artificial intelligence (AI) technology. In this case, a workload may be streaming data such as an image or audio used for the inference processing. A workload may be plaintext data to be encrypted by encryption processing of an information processing apparatus. A workload may be encrypted data to be decrypted by decryption processing of an information processing apparatus. A workload may be other data. The workload aggregation system 1 includes a plurality of information processing apparatuses, a plurality of accelerators, a control apparatus 30, and a connection device 40.

The plurality of information processing apparatuses include, for example, information processing apparatuses 10, 10a, …, 10x. The information processing apparatuses 10, 10a, …, 10x process a plurality of workloads in a distributed manner. The information processing apparatuses 10, 10a, …, 10x include processors 11, 11a, …, 11x, respectively. Each of the processors 11, 11a, …, 11xis, for example, a central processing unit (CPU) or a digital signal processor (DSP). Although not illustrated, the information processing apparatuses 10, 10a, …, 10x each include a memory such as a random access memory (RAM) that stores programs and data. Each of the information processing apparatuses 10, 10a, …, 10x is connected to the connection device 40 via a predetermined interface.

The plurality of accelerators include, for example, accelerators 20, 20a, …, 20x, and 20y. The accelerators 20, 20a, …, 20x, and 20y are coprocessors connectable to the information processing apparatuses 10, 10a, …, 10x via the connection device 40. Each of the accelerators 20, 20a, …, 20x, and 20y is, for example, a GPU, a field programmable gate array (FPGA), or the like. The accelerators 20, 20a, …, 20x, and 20yare used for processing workloads received by their respective connection-destination information processing apparatuses. Each of the accelerators 20, 20a, …, 20x, and 20yis connected to the connection device 40 via a predetermined interface. One accelerator is connected to one information processing apparatus via the connection device 40. The connection device 40 is able to switch the information processing apparatus to which a certain accelerator is connected.

The control apparatus 30 controls the information processing apparatuses 10, 10a, …, 10x and the connection device 40. The control apparatus 30 includes a memory 31 and a processor 32. The memory 31 is, for example, a RAM. The processor 32 is, for example, a CPU or a DSP. The processor 32 executes a program stored in the memory 31. A set of a plurality of processors may be referred to as a “multiprocessor” or simply as a “processor”. The control apparatus 30 is connected to the information processing apparatuses 10, 10a, …, 10x and the connection device 40 via, for example, a network. The control apparatus 30 allocates a workload received from the outside to one of the information processing apparatuses.

The connection device 40 is a switch that switches the connection between the information processing apparatuses 10, 10a, …, 10x and the accelerators 20, 20a, …, 20x, and 20y. The connection device 40 may be referred to as a fabric switch. The connection device 40 is, for example, a peripheral component interconnect (PCI) switch. The PCI switch is able to connect the information processing apparatuses 10, 10a, …, 10x and the accelerators 20, 20a, …, 20x, and 20yvia a PCI-Express (PCIe) interface. The connection relationship between the information processing apparatuses 10, 10a, …, 10x and the accelerators 20, 20a, …, 20x, and 20y is controlled by the control apparatus 30. That is, the connection device 40 switches the information processing apparatuses as the connection destinations of the accelerators in accordance with instructions from the control apparatus 30.

For example, the information processing apparatus 10 is connected to the accelerator 20 via the connection device 40. In this case, the processor 11 is able to offload part of the processing of the workload to the accelerator 20. When the processor 11 uses the accelerator 20 as an offload destination, the load of the accelerator 20 is linked with an increase or decrease in the load of the processor 11. That is, when the load of the processor 11 increases, the load of the accelerator 20 also increases. When the load of the processor 11 decreases, the load of the accelerator 20 also decreases.

The information processing apparatus 10a is connected to the accelerator 20a via the connection device 40. The information processing apparatus 10xis managed as a spare. The information processing apparatus 10xis normally excluded from the workload allocation targets. The information processing apparatus 10x is normally powered off. It is assumed that the accelerators 20xand 20y are free accelerators that are not allocated to any information processing apparatus.

Here, the amount of workload per unit time allocated to a certain information processing apparatus may increase or decrease according to the workload occurrence status. For this reason, in the workload aggregation system 1, two or more information processing apparatuses may have spare capacity depending on the workload occurrence status. Therefore, the workload aggregation system 1 provides a function of aggregating the workloads processed by two or more information processing apparatuses having spare capacity into one information processing apparatus. The details are as follows.

First, the processor 32 detects that a plurality of workloads processed by a first information processing apparatus and a second information processing apparatus are aggregatable into one information processing apparatus based on the loads of the processors 11, 11a, etc. For example, the processor 32 compares the sum of the load of a first processor included in the first information processing apparatus and the load of a second processor included in the second information processing apparatus with a threshold. If the sum is smaller than the threshold, the processor 32 determines that the plurality of workloads processed by the first information processing apparatus and the second information processing apparatus are aggregatable into one information processing apparatus. Here, the load of a processor is, for example, the usage of the processor. The threshold is, for example, the upper limit value of the load of the processor allowed for the one information processing apparatus. For example, the threshold is determined in advance with respect to the usage of the processor, such as 100% or 90%.

The processor 32 may determine whether the workloads of three or more information processing apparatuses including the first information processing apparatus and the second information processing apparatus are aggregatable into one information processing apparatus. In the case of determining whether the workloads of three or more information processing apparatuses are aggregatable, the processor 32 may compare the sum of the loads of the processors of the three or more information processing apparatuses with a threshold.

In addition, the processor 32 may perform the following workload aggregation when the processor 32 compares the sum of the loads of the processors with a threshold and detects that the sum has been higher than the threshold for a certain period of time.

Hereinafter, an example in which the first information processing apparatus is the information processing apparatus 10 and the second information processing apparatus is the information processing apparatus 10a will be described.

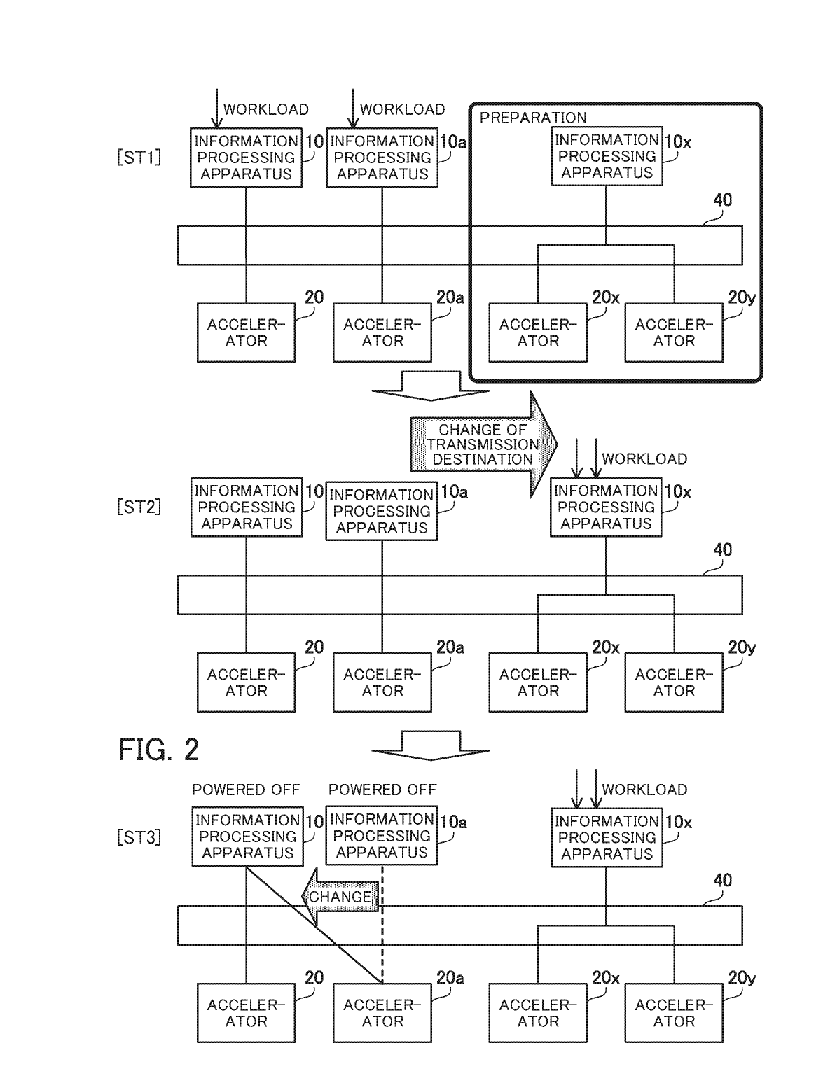

FIG. 2 is a diagram illustrating a processing example of the workload aggregation system. The processor 32 executes the following steps ST1 to ST5.

The processor 32 prepares a third information processing apparatus to which accelerators different from the accelerators 20 and 20a are connected (step ST1). Specifically, the processor 32 determines the number of accelerators to be connected to the third information processing apparatus based on the number of accelerators 20 and 20a used in the offload-source information processing apparatuses 10 and 10a. For example, the processor 32 sets the number of accelerators to be connected to the third information processing apparatus to be the same as the number of accelerators 20 and 20a used in the offload-source information processing apparatuses 10 and 10a. For example, the processor 32 uses the information processing apparatus 10x as the third information processing apparatus. The number of accelerators 20 and 20a is two. Therefore, the processor 32 connects the two free accelerators 20x and 20y to the information processing apparatus 10x, using the connection device 40. Next, the processor 32 activates the information processing apparatus 10x. For example, the processor 32 is able to power on the information processing apparatus 10x by transmitting a power-on request to the information processing apparatus 10x. This completes the preparation of the third information processing apparatus.

The processor 32 may increase the number of accelerators connected to the third information processing apparatus by a predetermined number from the number of accelerators 20 and 20a used in the offload-source information processing apparatuses 10 and 10a, for example.

The processor 32 changes the transmission destination of the plurality of workloads being transmitted to the information processing apparatuses 10 and 10a to the information processing apparatus 10x (step ST2). As a result, the plurality of workloads processed by the information processing apparatuses 10 and 10a are offloaded to the information processing apparatus 10x. The information processing apparatus 10xtakes over the processing of the plurality of workloads.

The processor 32 powers off the information processing apparatuses 10 and 10a. For example, the processor 32 is able to power off the information processing apparatuses 10 and 10a by transmitting a power-off request to the information processing apparatuses 10 and 10a. Next, the processor 32 changes the connection destination of the accelerator 20a to the information processing apparatus 10, using the connection device 40 (step ST3). For example, information indicating priorities of the information processing apparatuses 10 and 10a as aggregation destinations is held in the memory 31 in advance. Based on the priorities, the processor 32 specifies the information processing apparatus from which the accelerator is reallocated and the information processing apparatus to which the accelerator is reallocated. The information processing apparatus having the highest priority is the reallocation destination, and the other information processing apparatus is the reallocation source. The reallocation-destination information processing apparatus corresponds to the information processing apparatus to which the workloads are aggregated.

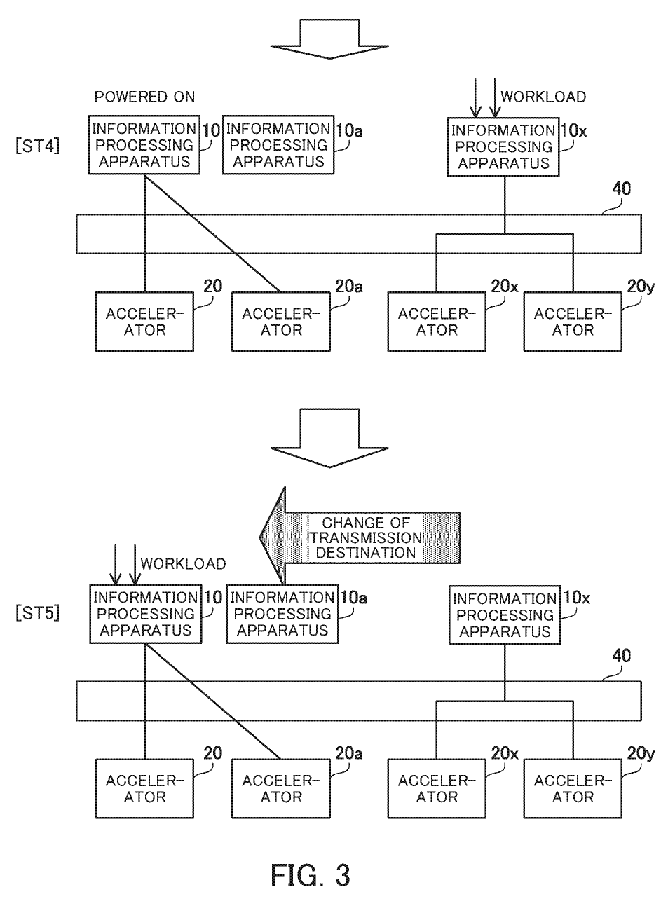

FIG. 3 is a diagram illustrating a processing example of the workload aggregation system. Next, the processor 32 powers on the information processing apparatus 10 (step ST4). For example, the processor 32 is able to power on the information processing apparatus 10 by transmitting a power-on request to the information processing apparatus 10. Accordingly, the information processing apparatus 10 is activated in a state where the accelerators 20 and 20a are connected to the information processing apparatus 10.

The processor 32 changes the transmission destination of the plurality of workloads being transmitted to the information processing apparatus 10x to the information processing apparatus 10 (step ST5). The information processing apparatus 10 takes over the processing of the plurality of workloads. The processor 11 is able to offload part of the processing of the plurality of workloads to the accelerators 20 and 20a.

After step ST5, the processor 32 powers off the information processing apparatus 10x, to set the information processing apparatus 10x as a spare apparatus. The processor 32 disconnects the accelerators 20x and 20y from the information processing apparatus 10x, and makes the accelerators 20x and 20y free again. As a result, the information processing apparatus 10x and the accelerators 20x and 20y become available for aggregation of workloads for a set of other information processing apparatuses.

As described above, according to the workload aggregation system 1, it is detected that the plurality of workloads processed by the first information processing apparatus and the second information processing apparatus are aggregatable into one information processing apparatus, based on the load of the processor of each of the plurality of information processing apparatuses. A first accelerator is connected to the first information processing apparatus. A second accelerator is connected to the second information processing apparatus. A third information processing apparatus to which an accelerator different from the first accelerator and the second accelerator is connected is prepared. The transmission destination of the plurality of workloads is changed to the third information processing apparatus. The first information processing apparatus and the second information processing apparatus are powered off. The connection destination of the second accelerator is changed to the first information processing apparatus. The first information processing apparatus is powered on. The transmission destination of the plurality of workloads is changed to the first information processing apparatus.

As a result, the workload aggregation system 1 is able to prevent interruption of the processing. When reallocating the accelerator, the workload aggregation system 1 temporarily offloads the workloads to the offload-destination information processing apparatus, reallocates an accelerator in the offload-source information processing apparatus, and performs restart. Therefore, the workload aggregation system 1 is able to process the workloads in the offload-destination information processing apparatus during the reallocation of the accelerator and the restart, and is able to prevent the interruption of the processing of the workloads. For example, the workload aggregation system 1 may interrupt the processing of the workloads to such an extent that the user is unaware of the interruption, or to such an extent that is virtually no interruption.

In addition, the workload aggregation system 1 is able to improve the operating rate of the entire system, and is able to reduce the power consumption by reallocating the accelerator without interrupting the workload processing. Furthermore, the workload aggregation system 1 is able to reduce the number of information processing apparatuses used for operation, and is able to efficiently use the resources such as the information processing apparatuses.

For example, in the preparation of the third information processing apparatus, the control apparatus 30 determines the number of accelerators to be connected to the third information processing apparatus based on the number of accelerators connected to the first information processing apparatus and the second information processing apparatus. The control apparatus 30 connects the determined number of accelerators to the third information processing apparatus that is powered off, and powers on the third information processing apparatus. Thus, the workload aggregation system 1 is able to appropriately determine the number of accelerators to be connected to the third information processing apparatus. As a result, the workload aggregation system 1 is able to suppress overloading of the accelerators in the third information processing apparatus, and is able to prevent delay in workload processing.

For example, the control apparatus 30 may set the number of accelerators to be connected to the third information processing apparatus to the same number as the number of accelerators connected to the first information processing apparatus and the second information processing apparatus. The control apparatus 30 may set the number of accelerators to be connected to the third information processing apparatus to be larger than the number of accelerators connected to the first information processing apparatus and the second information processing apparatus.

After changing the transmission destination of the plurality of workloads from the third information processing apparatus to the first information processing apparatus, the control apparatus 30 powers off the third information processing apparatus and disconnects the accelerators connected to the third information processing apparatus from the third information processing apparatus. As a result, the workload aggregation system 1 is able to reuse the accelerators and the third information processing apparatus for offloading workloads of a combination of other information processing apparatuses.

Upon detecting that the plurality of workloads are aggregatable, the control apparatus 30 compares the sum of the load of the first processor included in the first information processing apparatus and the load of the second processor included in the second information processing apparatus with a first threshold. When the sum is smaller than the first threshold, the control apparatus 30 determines that the plurality of workloads processed by the first information processing apparatus and the second information processing apparatus are aggregatable into one information processing apparatus. Thus, the workload aggregation system 1 is able to efficiently determine whether a plurality of workloads are aggregatable.

Further, after changing the transmission destination of the plurality of workloads to the first information processing apparatus, the control apparatus 30 may distribute the plurality of workloads if the control apparatus 30 detects that the load of the first processor included in the first information processing apparatus is larger than a second threshold.

Specifically, if the control apparatus 30 detects that the load of the first processor is larger than the second threshold, the control apparatus 30 prepares a fourth information processing apparatus to which accelerators different from the first accelerator and the second accelerator among the plurality of accelerators are connected. The control apparatus 30 changes the transmission destination of the plurality of workloads to the fourth information processing apparatus. The control apparatus 30 powers off the first information processing apparatus. The control apparatus 30 changes the connection destination of the first accelerator and the second accelerator to a fifth information processing apparatus among the plurality of information processing apparatuses. At this time, the fifth information processing apparatus is powered off. The control apparatus 30 powers on the first information processing apparatus and the fifth information processing apparatus. The control apparatus 30 changes the transmission destination of a first workload among the plurality of workloads to the first information processing apparatus, and changes the transmission destination of a second workload among the plurality of workloads to the fifth information processing apparatus. As described above, after the workload aggregation, the workload aggregation system 1 allocates the workload processing again according to the load of the processor of the aggregation-destination information processing apparatus. In this way, the workload aggregation system 1 is able to suppress the overload of the aggregation-destination information processing apparatus, and is able to prevent the delay of the workload processing.

For example, a value such as 90% is determined in advance as the second threshold, which is compared with the processor usage. When the load of the first processor and the second threshold are compared, if it is detected that the load of the first processor has been higher than the second threshold for a certain period of time, the control apparatus 30 may perform the above-described allocation. The fourth information processing apparatus may be the same as the third information processing apparatus. The fifth information processing apparatus may be the same as the second information processing apparatus.

### Modification

Although the workload aggregation system 1 uses the third information processing apparatus as a temporary offload destination and causes the first information processing apparatus to execute the workload processing again, the workload aggregation system 1 does not need to cause the first information processing apparatus to execute the workload processing again. That is, the workload aggregation system 1 may use the third information processing apparatus for the actual workload processing.

Specifically, the control apparatus 30 detects that the plurality of workloads processed by the first information processing apparatus and the second information processing apparatus are aggregatable into one information processing apparatus, based on the load of the processor of each of the plurality of information processing apparatuses. A first accelerator is connected to the first information processing apparatus. A second accelerator is connected to the second information processing apparatus. The control apparatus 30 connects a third accelerator and a fourth accelerator among the plurality of accelerators to the third information processing apparatus that is powered off. Next, the control apparatus 30 determines the number of accelerators to be connected to the third information processing apparatus based on the number of accelerators connected to the first information processing apparatus and the second information processing apparatus. The control apparatus 30 powers on the third information processing apparatus. The control apparatus 30 changes the transmission destination of the plurality of workloads to the third information processing apparatus. In this way, the workload aggregation system 1 is able to prevent interruption of the processing when aggregating the workloads.

In the case of the modification, after changing the transmission destination of the plurality of workloads to the third information processing apparatus, the control apparatus 30 powers off the first information processing apparatus and the second information processing apparatus. In addition, the control apparatus 30 disconnects the first information processing apparatus from the first accelerator, and disconnects the second information processing apparatus from the second accelerator. In this way, the workload aggregation system 1 is able to reuse the first information processing apparatus, the second information processing apparatus, the first accelerator, and the second accelerator for other processing such as aggregation of workloads for a set of other information processing apparatuses.

In the above modification, the workload aggregation system 1 performs additional management processing such as managing another information processing apparatus as a new spare apparatus.

On the other hand, when the workload aggregation system 1 causes the first information processing apparatus to execute the workload processing again, the additional management processing according to the modification does not be performed, which is an advantageous point.

### Second Embodiment

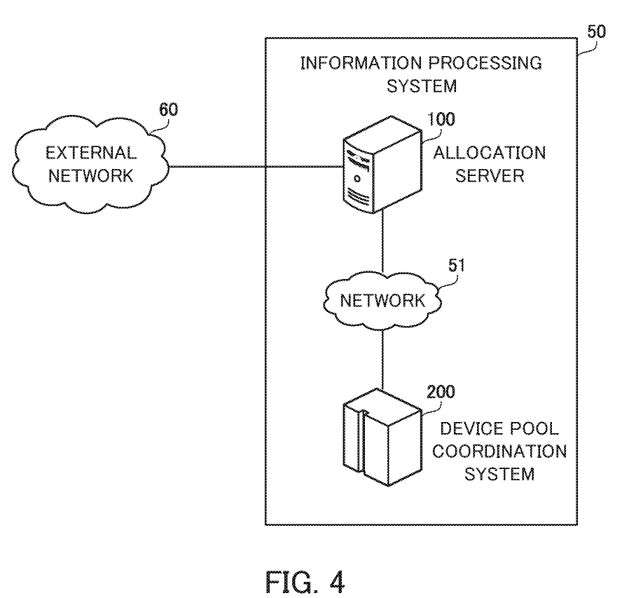

FIG. 4 is a diagram illustrating an example of an information processing system according to a second embodiment. The information processing system 50 executes inference processing based on workloads received from an external network 60. The external network 60 is, for example, the Internet. For example, the information processing system 50 is used for a service in which a person, an object, or the like is detected through inference by AI based on an image of a monitoring camera installed in a city or a road, so as to visualize the number of people, a flow of people, or the like. The information processing system 50 includes a network 51, an allocation server 100, and a device pool coordination system 200. The network 51 is an internal network of the information processing system 50.

The allocation server 100 is a computer that allocates a plurality of workloads received from the external network 60 to a plurality of calculation servers included in the device pool coordination system 200 via the network 51. The allocation server 100 is an example of the control apparatus 30 according to the first embodiment.

The device pool coordination system 200 is a subsystem of the information processing system 50. The device pool coordination system 200 includes a plurality of calculation servers and a plurality of GPUs used for inference processing. The device pool coordination system 200 enables reallocation of GPUs to calculation servers.

The information processing system 50 is an example of the workload aggregation system 1 according to the first embodiment.

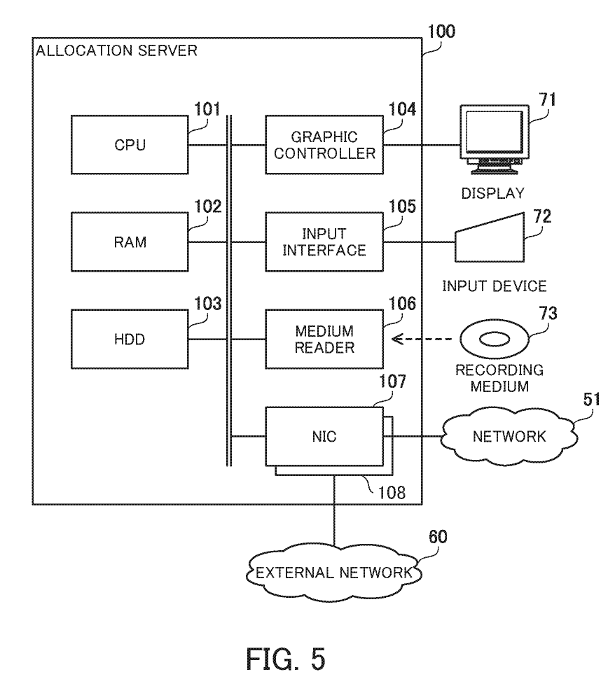

FIG. 5 is a diagram illustrating a hardware example of the allocation server. The allocation server 100 includes a CPU 101, a RAM 102, an HDD 103, a graphic controller 104, an input interface 105, a medium reader 106, and network interface cards (NICs) 107 and 108. These units included in the allocation server 100 are connected to a bus inside the allocation server 100. The CPU 101 is an example of the processor 32 according to the first embodiment. The RAM 102 or the HDD 103 is an example of the memory 31 according to the first embodiment.

The CPU 101 is an arithmetic unit that executes instructions of programs. The CPU 101 is, for example, a CPU. The CPU 101 loads a program and at least a part of data stored in the HDD 103 into the RAM 102, and executes the program. The CPU 101 may include a plurality of processor cores. The allocation server 100 may include a plurality of CPUs. A CPU that executes a certain process among a plurality of processes executed by the allocation server 100 may be different from a CPU that executes a process different from the certain process among the plurality of processes.

At least part of the processing described below may be executed in parallel, using a plurality of processors including the CPU 101 or processor cores. A set of a plurality of processors may be referred to as a “multiprocessor” or simply as a “processor”. “Processor” may be referred to as “processor circuitry”.

The RAM 102 is a volatile semiconductor memory that temporarily stores programs executed by the CPU 101 and data used by the CPU 101 for calculation. The allocation server 100 may include a memory of a type other than the RAM, or may include a plurality of memories.

The HDD 103 is a non-volatile storage device that stores software programs such as an operating system (OS), middleware, and application software, and data. The allocation server 100 may include another type of storage device such as a flash memory or a solid state drive (SSD), or may include a plurality of non-volatile storage devices.

The graphic controller 104 outputs an image to a display 71 connected to the allocation server 100 in accordance with an instruction from the CPU 101. The display 71 is, for example, a cathode ray tube (CRT) display, a liquid crystal display (LCD), a plasma display, or an organic electro-luminescence (OEL) display. The graphic controller 104 is, for example, a GPU. The graphic controller 104 may be a controller built in a chipset.

The input interface 105 acquires an input signal from the input device 72 connected to the allocation server 100, and outputs the input signal to the CPU 101. A pointing device such as a mouse, a touch panel, a touch pad, or a trackball, a keyboard, a remote controller, a button switch, or the like may be used as the input device 72. A plurality of types of input devices may be connected to the allocation server 100.

The medium reader 106 is a reading device that reads programs and data recorded in a recording medium 73. For example, a magnetic disk, an optical disc, a magneto-optical disk (MO), a semiconductor memory, or the like may be used as the recording medium 73. Examples of the magnetic disk include a flexible disk (FD) and an HDD. Examples of the optical disc include a CD (Compact Disc) and a DVD (Digital Versatile Disc).

For example, the medium reader 106 copies a program or data read from the recording medium 73 to another recording medium such as the RAM 102 or the HDD 103. The read program is executed by, for example, the CPU 101. The recording medium 73 may be a portable recording medium, and may be used to distribute programs and data. The recording medium 73 or the HDD 103 may be referred to as a computer-readable recording medium.

The NIC 107 is connected to the network 51 and communicates with other information processing apparatuses in the device pool coordination system 200 via the network 51. The NIC 108 is connected to the external network 60 and communicates with another external information processing apparatus via the external network 60. The NICs 107 and 108 may be wired interfaces connected to wired communication devices such as switches and routers, or may be wireless interfaces connected to wireless communication devices such as base stations and access points.

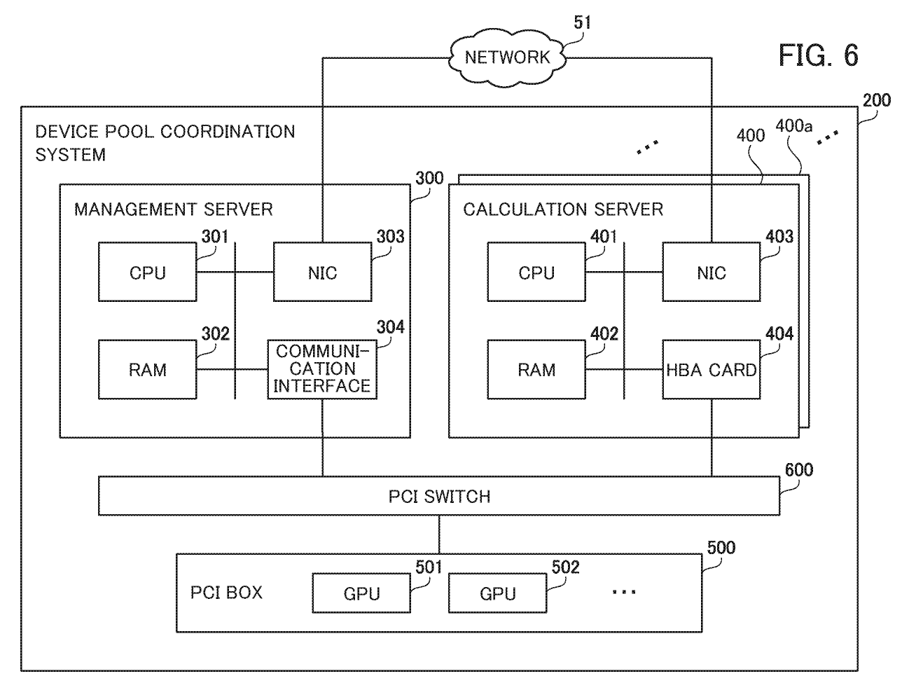

FIG. 6 is a diagram illustrating a hardware example of the device pool coordination system. The device pool coordination system 200 includes a management server 300, calculation servers 400, 400a, etc., a PCI box 500, and a PCI switch 600.

The management server 300 is a computer that manages the calculation servers 400, 400a, etc., and the PCI switch 600. The management server 300 includes a CPU 301, a RAM 302, an NIC 303, and a communication interface 304. The CPU 301 is an arithmetic unit that executes instructions of programs. The RAM 302 stores programs and data. The NIC 303 is an interface connected to the network 51. The communication interface 304 is an interface connected to the PCI switch 600.

The calculation servers 400, 400a, etc., are computers used for workload processing. The calculation server 400 includes a CPU 401, a RAM 402, an NIC 403, and a host bus adapter (HBA) card 404. The CPU 401 is an arithmetic unit that executes instructions of a program. The RAM 402 stores programs and data. The NIC 403 is an interface connected to the network 51. The HBA card 404 is an interface connected to the PCI switch 600. The calculation servers 400a, etc., have hardware similar to that of the calculation server 400. The calculation servers 400, 400a, etc., have the same performance.

The PCI box 500 is a housing that houses GPUs 501, 502, etc. The GPUs 501, 502, etc., are accelerators used as offload destinations of the processing of the calculation servers 400, 400a, etc. The GPUs 501, 502, etc., are examples of the accelerators 20, 20a, …, 20x, and 20y according to the first embodiment. The GPUs 501, 502, etc., have the same performance.

The PCI switch 600 is a switch that connects the calculation servers and the GPUs included in the calculation servers 400, 400a, etc., and the GPUs 501, 502, etc., via PCIe interfaces. The PCI switch 600 is an example of the connection device 40 according to the first embodiment. The PCI switch 600 increases or decreases the number of GPUs connected to a certain calculation server according to an instruction from the management server 300.

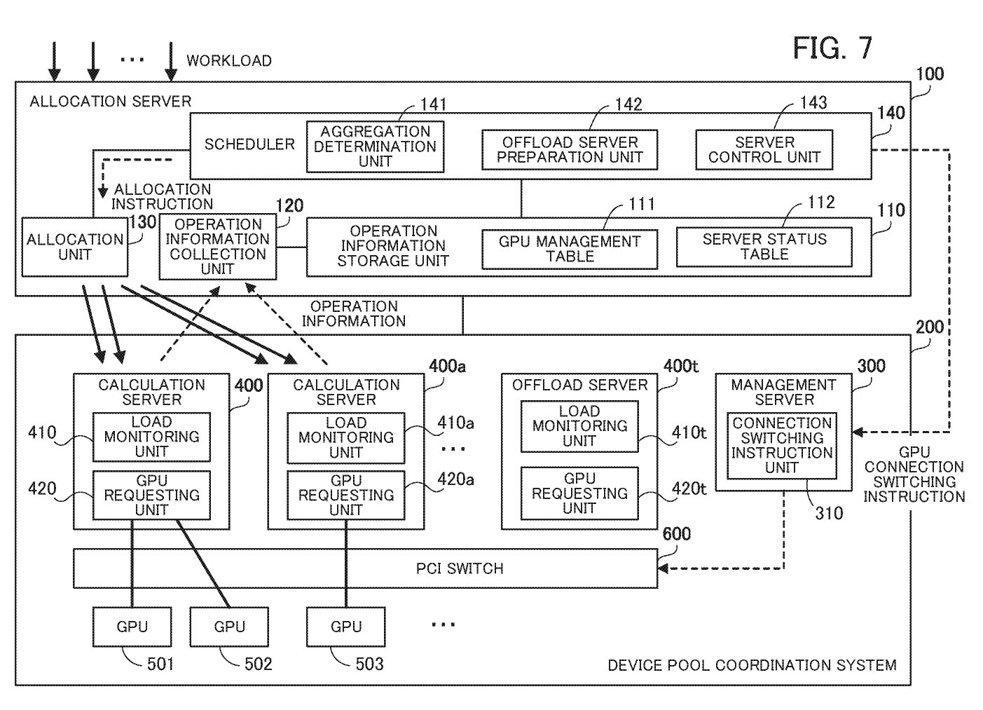

FIG. 7 is a diagram illustrating a functional example of the information processing system. The allocation server 100 includes an operation information storage unit 110, an operation information collection unit 120, an allocation unit 130, and a scheduler 140. A storage area of the RAM 102 or the HDD 103 is used as the operation information storage unit 110. The operation information collection unit 120, the allocation unit 130, and the scheduler 140 are implemented by the CPU 101 executing a program stored in the RAM 102.

The operation information storage unit 110 stores operation information. Specifically, the operation information storage unit 110 stores a GPU management table 111 and a server status table 112.

The GPU management table 111 stores information used for GPU management. The GPU management table 111 stores information per GPU. For example, the GPU management table 111 stores information indicating whether a GPU has been allocated to a calculation server. If a GPU has been allocated to a calculation server, information about the calculation server to which this GPU has been allocated is stored, and information such as the load of the GPU is also stored.

The server status table 112 stores information about the status of each calculation server. The server status table 112 holds information such as a power supply state, an allocated GPU, a processing target workload, and a CPU load, for each calculation server.

The operation information collection unit 120 collects operation information from the calculation servers 400, 400a, etc. The operation information collection unit 120 records the collected operation information in the GPU management table 111 and the server status table 112.

The allocation unit 130 allocates a plurality of workloads received from the external network 60 to the calculation servers 400, 400a, etc. A workload is identified by, for example, identification information of connection used by the allocation server 100 to receive the workload. The allocation unit 130 changes a calculation server to which a workload has been allocated, based on an allocation instruction from the scheduler 140.

The scheduler 140 controls workload aggregation. The workload aggregation indicates that a plurality of workloads processed by two or more calculation servers are aggregated into one calculation server. The scheduler 140 includes an aggregation determination unit 141, an offload server preparation unit 142, and a server control unit 143.

The aggregation determination unit 141 determines whether a plurality of workloads processed by two or more calculation servers are aggregatable into one calculation server based on the load of the CPU of each of the calculation servers 400, 400a, etc. Specifically, when the sum of the CPU usages of two or more calculation servers is less than 100%, the aggregation determination unit 141 determines that the workloads processed by the two or more calculation servers are aggregatable into one calculation server.

The offload server preparation unit 142 prepares an offload server. The offload server is a calculation server serving as a temporary offload destination of a plurality of workloads processed by two or more calculation servers. The offload server preparation unit 142 connects a predetermined number of GPUs to the offload server, and starts the offload server in order to offload the workloads. Among the calculation servers 400, 400a, etc., a spare calculation server is used as the offload server. A predetermined number of calculation servers among the calculation servers 400, 400a, etc., are managed in advance as spare machines. Information indicating which calculation servers are spare machines is stored in advance in the operation information storage unit 110.

The server control unit 143 controls the calculation servers 400, 400a, etc., and the management server 300. For example, the server control unit 143 controls power-on and power-off of the calculation servers 400, 400a, etc. The server control unit 143 outputs a GPU connection switching instruction to the management server 300. The GPU connection switching instruction is an instruction to switch a calculation server to which a GPU is connected. The server control unit 143 outputs a workload allocation instruction to the allocation unit 130. The allocation instruction is a designation of a calculation server to which a workload is to be allocated.

Here, the offload server preparation unit 142 and the server control unit 143 may power on or off the calculation servers 400, 400a, etc., via the management server 300, for example. For example, the offload server preparation unit 142 and the server control unit 143 may cause the management server 300 to power on or off a target calculation server by transmitting a power-on or power-off request specifying the target calculation server to the management server 300. Alternatively, the offload server preparation unit 142 and the server control unit 143 may power on or off a target calculation server by transmitting a power-on or power-off request to the target calculation server.

The management server 300 includes a connection switching instruction unit 310. The connection switching instruction unit 310 is implemented by the CPU 301 executing a program stored in the RAM 302. The connection switching instruction unit 310 receives a GPU connection switching instruction from the allocation server 100. In response to the GPU connection switching instruction, the connection switching instruction unit 310 instructs the PCI switch 600 to switch the connection destination of the target GPU.

The calculation server 400 includes a load monitoring unit 410 and a GPU requesting unit 420. A calculation server 400aincludes a load monitoring unit 410a and a GPU requesting unit 420a. An offload server 400tincludes a load monitoring unit 410t and a GPU requesting unit 420t. The offload server 400tis a calculation server managed as a spare machine among the calculation servers 400, 400a, etc. A plurality of offload servers 400tmay be provided. Hereinafter, the calculation server 400 will be mainly described. However, the calculation servers 400a, etc., including the offload server 400thave the same function.

The load monitoring unit 410 and the GPU requesting unit 420 are implemented by the CPU 401 executing a program stored in the RAM 402.

The load monitoring unit 410 monitors the load of the CPU 401 and the load of the GPU connected to the calculation server 400. The load of the CPU 401 is the usage of the CPU 401. The load of the GPU is the usage of the GPU. For example, it is assumed that the GPUs 501 and 502 are connected to the calculation server 400. The load monitoring unit 410 periodically transmits operation information including the usage of the CPU 401, the usage of the GPU 501, and the usage of the GPU 502 to the allocation server 100. The GPU requesting unit 420 offloads part of the workload processing of the CPU 401 to the GPUs 501 and 502. Accordingly, the calculation server 400 is able to inference processing using the GPUs 501 and 502.

The GPU 503 is connected to the calculation server 400a. The load monitoring unit 410aperiodically transmits operation information including the usage of the CPU of the calculation server 400a and the usage of the GPU 503 to the allocation server 100. The offload server 400tmay be powered off in a normal state.

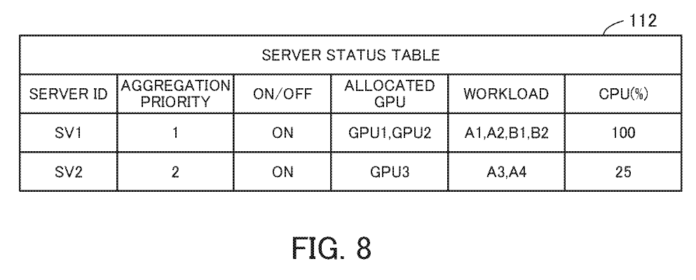

FIG. 8 is a diagram illustrating an example of the server status table. The server status table 112 includes columns “server ID (IDentifier)”, “aggregation priority”, “ON/OFF”, “allocated GPU”, “workload”, and “CPU(%)”.

In a field under “server ID”, identification information of a calculation server is registered. In a field under “aggregation priority”, an aggregation priority used for selecting an aggregation destination is registered. The smaller the value of the aggregation priority, the higher the degree of priority. Information indicating whether the corresponding calculation server is currently powered on or off is registered in a field under “ON/OFF”. In a field under “allocated GPU”, identification information of a GPU allocated to the corresponding calculation server is registered. In a field under “workload”, identification information of a workload allocated to the corresponding calculation server is registered. In a field under “CPU(%)”, the usage of the corresponding CPU is registered.

For example, the server status table 112 has a record including “SV1” under “server ID”, “1” under “aggregation priority”, “ON” under “ON/OFF”, “GPU1, GPU2” under “allocated GPU”, “A1, A2, B1, B2” under “workload”, and “100” under “CPU(%)”. The server ID “SV1” is the ID of the calculation server 400. “GPU1” is the identification information of the GPU 501. “GPU2” is the identification information of the GPU 502.

The server status table 112 includes a record including “SV2” under “server ID”, “2” under “aggregation priority”, “ON” under “ON/OFF”, “GPU3” under “allocated GPU”, “A3, A4” under “workload”, and “25” under “CPU(%)”. The server ID “SV2” is the identification information of the calculation server 400a. “GPU3” is the identification information of the GPU 503.

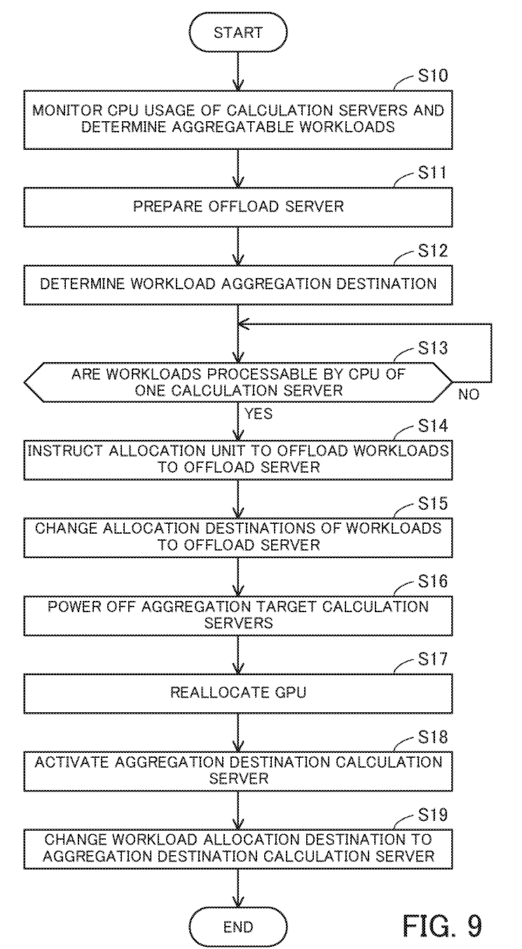

FIG. 9 is a flowchart illustrating an example of workload aggregation processing.

(S10) The aggregation determination unit 141 monitors the usages of the CPUs of the calculation servers 400, 400a, etc., and determines aggregatable workloads. Specifically, for each combination of two or more calculation servers, the aggregation determination unit 141 compares the sum of the usages of the CPUs of two or more calculation servers with a threshold (= 100%). If the sum of the usages of the CPUs of a certain combination of two or more calculation servers is less than the threshold, the aggregation determination unit 141 determines that the workloads processed by the two or more calculation servers are aggregatable into one calculation server. For example, the aggregation determination unit 141 uses the sum of the average values of the CPU usages of the individual calculation servers in a recent certain period for the determination in step S10.

(S11) The offload server preparation unit 142 prepares the offload server 400t. Specifically, the offload server preparation unit 142 determines the number of GPUs to be connected to the offload server 400t based on the number of GPUs used in the two or more aggregation target calculation servers. For example, the offload server preparation unit 142 determines to connect the same number of GPUs as the number of GPUs used in the two or more aggregation target calculation servers to the offload server 400t. The offload server preparation unit 142 connects the determined number of free GPUs to the offload server 400t, and starts the offload server 400t.

(S12) The server control unit 143 determines a workload aggregation destination based on the aggregation priorities of the server status table 112. For example, the server control unit 143 determines, as the aggregation destination, a calculation server having the highest aggregation priority among the two or more aggregation target calculation servers.

(S13) The aggregation determination unit 141 determines whether the processing of the CPUs for the workloads of the two or more aggregation target calculation servers is processable by the CPU of one calculation server. Specifically, the aggregation determination unit 141 compares the sum of the CPU usages of the two or more aggregation target calculation servers with a threshold (= 100%). If the sum of the CPU usages of the two or more calculation servers is less than the threshold, the aggregation determination unit 141 determines that the CPU of one calculation server is able to perform the processing. If the aggregation determination unit 141 determines that the CPU of one calculation server is able to perform the processing, the processing proceeds to step S14. If the aggregation determination unit 141 does not determine that the CPU of one calculation server is able to perform the processing, the processing proceeds to step S13, and step S13 is repeatedly executed. In the determination in step S13, for the sum of the average values of the CPU usages, a recent period shorter than the period used in the determination in step S10 may be used.

(S14) The server control unit 143 instructs the allocation unit 130 to offload the workloads to the offload server 400t. Specifically, the server control unit 143 outputs an allocation instruction to the allocation unit 130, so as to change the allocation destinations of the plurality of workloads, which have been allocated to the two or more calculation servers, to the offload server 400t.

(S15) The allocation unit 130 changes the allocation destinations of the workloads to the offload server 400t based on the allocation instruction from the server control unit 143.

(S16) The server control unit 143 powers off the aggregation target calculation servers. As a result, the two or more aggregation target calculation servers are powered off.

(S17) The server control unit 143 reallocates a GPU. Specifically, the server control unit 143 transmits, to the management server 300, a GPU connection switching instruction indicating that the connection destination of a GPU connected to a calculation server other than the aggregation destination calculation server among the two or more aggregation target calculation servers is to be changed to the aggregation destination calculation server. Then, the connection switching instruction unit 310 changes the connection destination of the GPU, using the PCI switch 600, based on the GPU connection switching instruction. It may be said that step S17 is a process in which the server control unit 143 changes the connection destination of a GPU by using the management server 300 and the PCI switch 600.

(S18) The server control unit 143 activates the aggregation destination calculation server. That is, the server control unit 143 powers on the aggregation destination calculation server.

(S19) The server control unit 143 changes the allocation destination of the workloads to the aggregation destination calculation server. Specifically, the server control unit 143 outputs an allocation instruction to the allocation unit 130, so as to change the allocation destination of the plurality of workloads, which have been allocated to the offload server 400t, to the aggregation destination calculation server. The allocation unit 130 changes the allocation destination of the plurality of workloads to the aggregation destination calculation server based on the allocation instruction. Then, the workload aggregation processing ends.

After step S19, the server control unit 143 powers off the offload server 400t. Next, the server control unit 143 disconnects the GPUs connected to the offload server 400t, to make the GPUs free again.

In step S10, the aggregation determination unit 141 may preferentially select a combination including a larger number of calculation servers, as the combination of two or more calculation servers and as the workload aggregation targets. This makes the workload aggregation more efficient. Specifically, it is possible to further improve the operating rate of the entire system and to further reduce the power consumption. In addition, it is possible to reduce the number of calculation servers used for the operation, and it is possible to use the resources of the calculation servers 400, 400a, etc., more efficiently.

In the procedure in FIG. 9, before the workload aggregation is performed, the CPU loads are checked again in step S13. As another example, after step S12, the procedure may skip step S13 and proceed to step S14.

Next, a specific example of the workload aggregation by the information processing system 50 will be described.

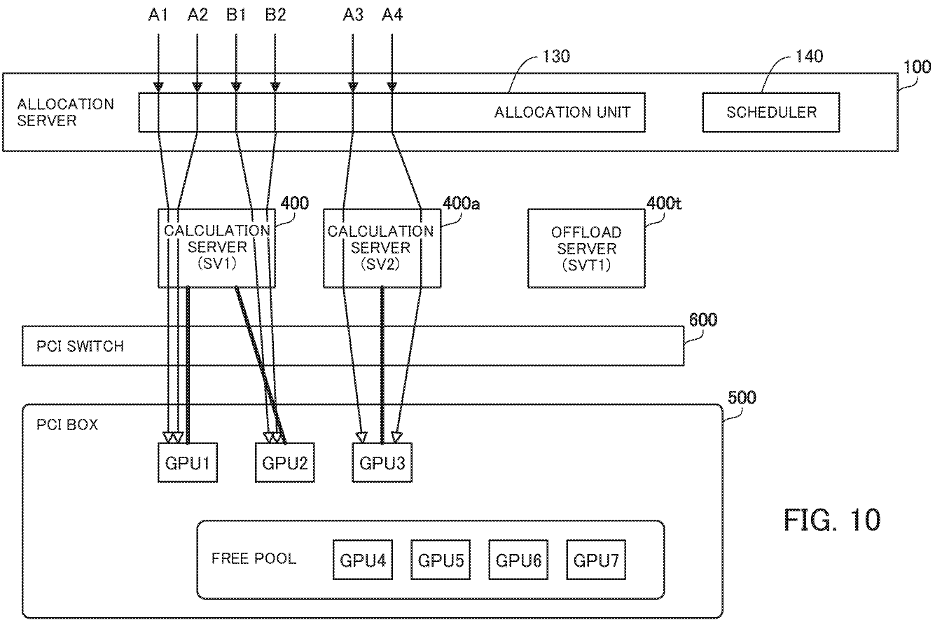

FIG. 10 is a diagram illustrating an example of workload allocation. As an example, the allocation server 100 receives workloads A1, A2, A3, A4, B1, and B2. The allocation unit 130 allocates the workloads A1, A2, A3, A4, B1, and B2 as follows. The allocation destination of the workloads A1, A2, B1, and B2 is the calculation server 400. The allocation destination of the workloads A3 and A4 is the calculation server 400a.

Hereinafter, the GPUs will be represented by their respective identification information. For example, the plurality of GPUs housed in the PCI box 500 include GPU1 to GPU7. The GPU1 and the GPU2 are connected to the calculation server 400 via the PCI switch 600. The GPU3 is connected to the calculation server 400avia the PCI switch 600. The GPU4 to GPU7 are free. A group of GPUs that are free is called a free pool. The offload server 400tis powered off.

The calculation server 400 offloads the processing of the workloads A1 and A2 to the GPU1. The calculation server 400 offloads the processing of the workloads B1 and B2 to the GPU2. The calculation server 400aoffloads the processing of the workloads A3 and A4 to the GPU3.

The scheduler 140 refers to the server status table 112 periodically or when the CPU load of the allocation server 100 is relatively low, and performs workload aggregation processing based on the CPU load of each of the calculation servers 400 and 400a.

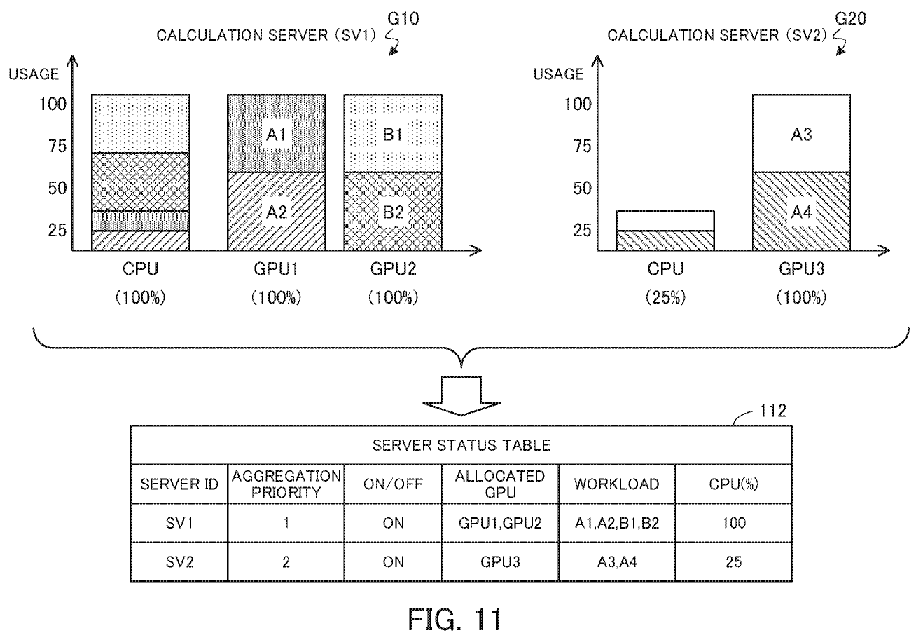

FIG. 11 is a diagram illustrating an example of the loads of the calculation servers. Graphs G10 and G20 indicate the CPU usages of the calculation servers 400 and 400a and the corresponding GPU usages corresponding to FIG. 10. The horizontal axes of the graphs G10 and G20 represent the CPUs and the GPUs. The vertical axes of the graphs G10 and G20 indicate the usages. The vertical axis and the horizontal axis of the graphs illustrated below represent the same as those of the graphs G10 and G20. In the graphs G10 and G20, the workloads A1 to A4, B1, and B2 are distinguished by hatching. The GPU usages in the graphs G10 and G20 are collected by, for example, the operation information collection unit 120 and recorded in the GPU management table 111.

The server status table 112 indicates the statuses of the calculation servers 400 and 400a corresponding to the graphs G10 and G20. In the server status table 112, the records of the calculation servers other than those of the calculation servers 400 and 400a are omitted. For example, the CPU usage of the calculation server 400 is 100%. The usage of the GPU1 is 100%. The usage of the GPU2 is 100%. The CPU usage of the calculation server 400ais 25%. The usage of the GPU3 is 100%.

A total of 125% of a CPU usage of 100% of the calculation server 400 and a CPU usage of 25% of the calculation server 400a is larger than the threshold 100%. Therefore, at this stage as illustrated in FIG. 11, the aggregation determination unit 141 does not determine that the workloads of the calculation servers 400 and 400a are aggregatable into one calculation server.

After that, the processing load on the workloads B1 and B2 decreases, and the server statuses of the calculation servers 400 and 400a change as follows.

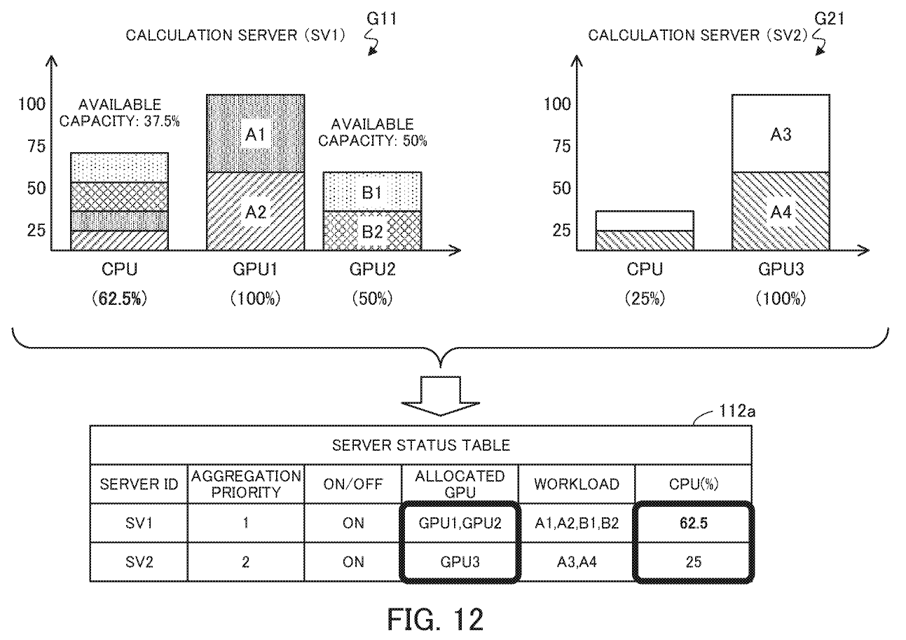

FIG. 12 is a diagram illustrating an example of the loads of the calculation servers. Graphs G11 and G21 indicate the CPU usages of the calculation servers 400 and 400a and the corresponding GPU usages. A server status table 112aindicates the statuses of the calculation servers 400 and 400a corresponding to the graphs G11 and G21.

The CPU usage of the calculation server 400 is 62.5%. The usage of the GPU1 is 100%. The usage of the GPU2 is 50%. The CPU usage of the calculation server 400a is 25%. The usage of the GPU3 is 100%.

As described above, since the processing load on the workloads B1 and B2 has been reduced, the CPU usage of the calculation server 400 and the usage of the GPU1 has also been reduced. A total of 87.5% of a CPU usage of 62.5% of the calculation server 400 and a CPU usage of 25% of the calculation server 400a is smaller than the threshold 100%.

For example, the aggregation determination unit 141 may determine whether the sum of the average value of the CPU usage of the calculation server 400 for a certain period of time and the average value of the CPU usage of the calculation server 400a for a certain period of time is smaller than a threshold. If the sum is smaller than the threshold, the aggregation determination unit 141 may determine that the workloads of the calculation servers 400 and 400a are aggregatable into one calculation server.

Alternatively, the aggregation determination unit 141 may determine whether a state in which the sum of the CPU usage of the calculation server 400 and the CPU usage of the calculation server 400a is smaller than a threshold has continued for a certain period of time. If the state in which the sum of the CPU usage of the calculation server 400 and the CPU usage of the calculation server 400a is smaller than a threshold has continued for a certain period of time, the aggregation determination unit 141 may determine that the workloads of the calculation servers 400 and 400a are aggregatable into one calculation server.

As a result of the determination based on the server status table 112a, the aggregation determination unit 141 determines that the workloads of the calculation servers 400 and 400a are aggregatable into one calculation server. The aggregation determination unit 141 instructs the offload server preparation unit 142 to start preparing the offload server 400t.

The offload server preparation unit 142 acquires the number of GPUs connected to the aggregation target calculation servers 400 and 400a. In this example, the number of GPUs connected to the aggregation target calculation servers 400 and 400a is three. Therefore, the offload server preparation unit 142 determines to connect three GPUs to the offload server 400t.

If the aggregation determination unit 141 determines that the workloads of the calculation servers 400 and 400a are aggregatable into one calculation server, the server control unit 143 determines the aggregation destination calculation server based on the aggregation priorities in the server status table 112a. For example, based on the server status table 112a, the server control unit 143 determines the calculation server 400 as the aggregation destination calculation server.

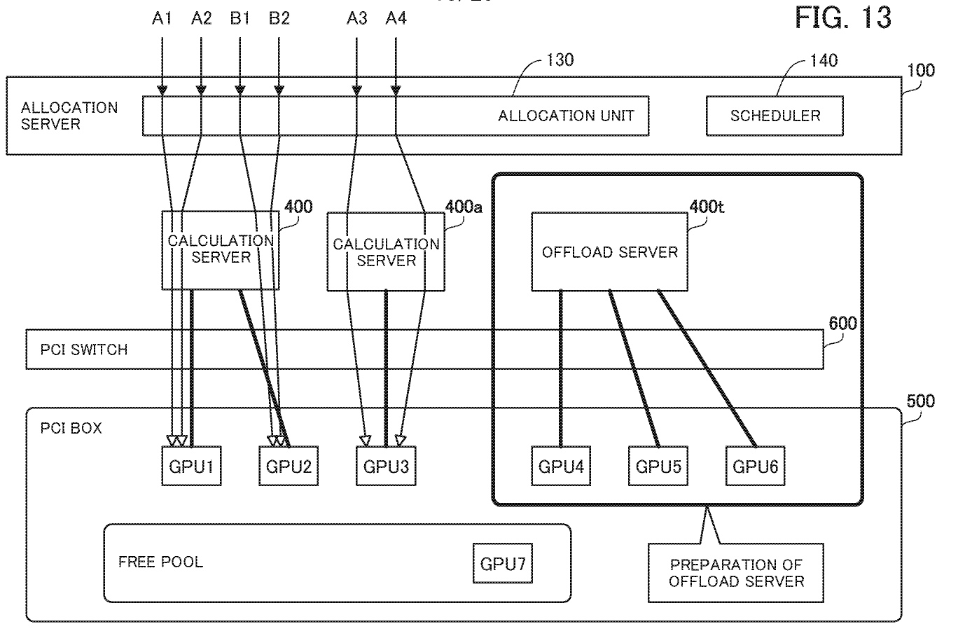

FIG. 13 is a diagram illustrating an example of preparation of an offload server. The offload server preparation unit 142 instructs the PCI switch 600 to connect three GPUs, which are the GPU4 to the GPU6, among those in the free pool, to the offload server 400t via the management server 300. In response to the instruction, the GPU4 to the GPU6 are connected to the offload server 400t by the PCI switch 600. Next, the offload server preparation unit 142 powers on the offload server 400t. The offload server preparation unit 142 registers information about the offload server 400t in the server status table 112a.

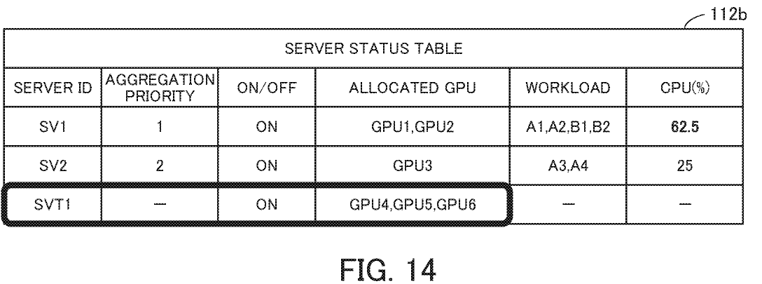

FIG. 14 is a diagram illustrating an example of registration of the offload server in the server status table. The server status table 112bindicates the status of the activated offload server 400t. The server status table 112bis obtained by registering information about the offload server 400t in the server status table 112a. The server status table 112b includes a record including “SVT1” under “server ID”, “-” under “aggregation priority”, “ON” under “ON/OFF”, “GPU4, GPU5, GPU6” under “allocated GPU”, “-” under “workload”, and “-” under “CPU(%)”. The server ID “SVT1” is the identification information of the offload server 400t. A hyphen “-” indicates no setting.

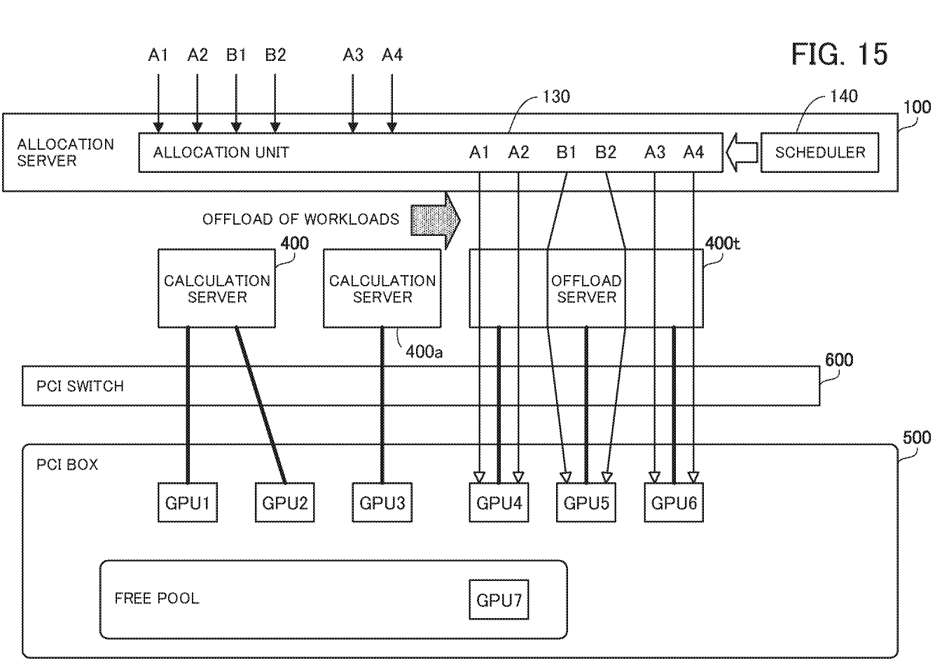

FIG. 15 is a diagram illustrating an example of offloading workloads to the offload server. After the offload server 400tis activated, the server control unit 143 instructs the allocation unit 130 to offload the workloads. Specifically, the server control unit 143 instructs the allocation unit 130 to change the allocation destination of the workloads A1 to A4, B1, and B2 from the calculation servers 400 and 400a to the offload server 400t.

The allocation unit 130 changes the allocation destination of the workloads A1 to A4, B1, and B2 from the calculation servers 400 and 400a to the offload server 400t based on the allocation instruction. As a result, the workloads A1 to A4, B1, and B2 are offloaded to the offload server 400t and are processed by the offload server 400t. The calculation servers 400 and 400awill no longer receive these workloads.

The offload server 400t offloads the processing of the workloads A1 to A4, B1, and B2 to the GPU4 to GPU6. Specifically, the offload server 400toffloads the processing of the workloads A1 and A2 to the GPU4. The offload server 400toffloads the processing of the workloads B1 and B2 to the GPU5. The offload server 400toffloads the processing of the workloads A3 and A4 to the GPU6.

The allocation unit 130 or the server control unit 143 may instruct the offload server 400t to select an offload destination GPU for each workload. For example, the offload destinations are specified such that the workloads are mapped in the same way as those with the GPU1 to GPU3 prior to the offloading. Specifically, the offload destinations are specified such that the workloads A1 and A2 processed by the GPU1 are offloaded to the GPU4, the workloads B1 and B2 processed by the GPU2 are offloaded to the GPU5, and the workloads A3 and A4 processed by the GPU3 are offloaded to the GPU6.

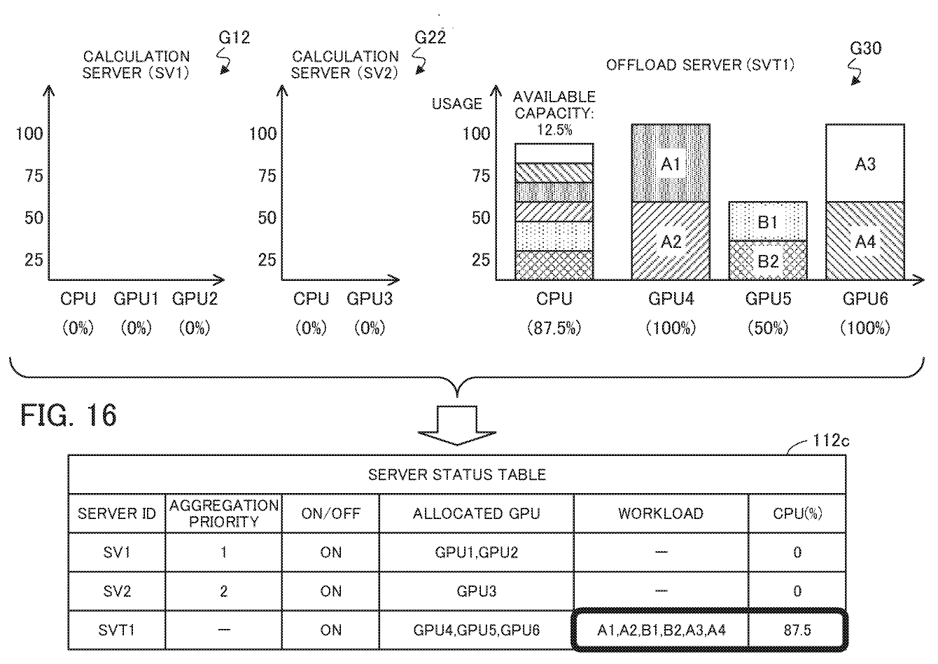

FIG. 16 is a diagram illustrating an example of the server status table obtained after the workloads are offloaded. Graphs G12 and G22 indicate the CPU usages of the calculation servers 400 and 400a and the corresponding GPU usages after the workloads are offloaded. A graph G30 indicates the CPU usage of the offload server 400t and the corresponding GPU usages after the workloads are offloaded.

A server status table 112c indicates the statuses of the calculation servers 400 and 400a and the offload server 400t corresponding to the graphs G12, G22, and G30. Since the calculation servers 400 and 400a will not receive these workloads, the CPU usages and the GPU usages are 0% or almost 0%. The CPU usage of the offload server 400t is 87.5%. The available capacity of the CPU usage of the offload server 400t is 12.5%. The usage of the GPU4 is 100%. The usage of the GPU5 is 50%. The usage of the GPU6 is 100%.

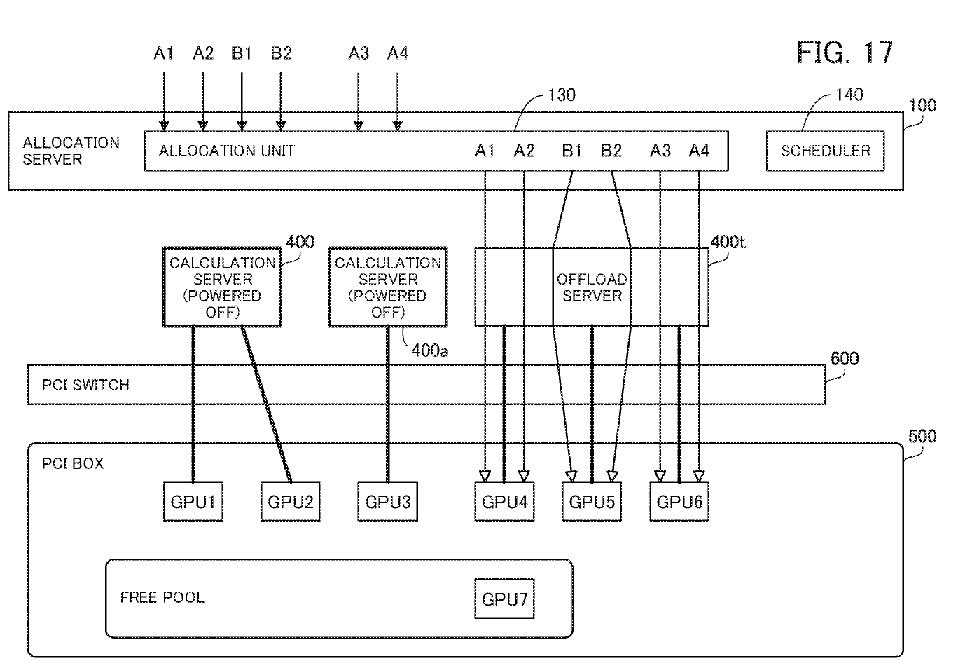

FIG. 17 is a diagram illustrating an example of power-off of calculation servers. After offloading the workloads, the server control unit 143 powers off the calculation servers 400 and 400a. The workloads A1 to A4, B1, and B2 are continuously processed by the offload server 400t.

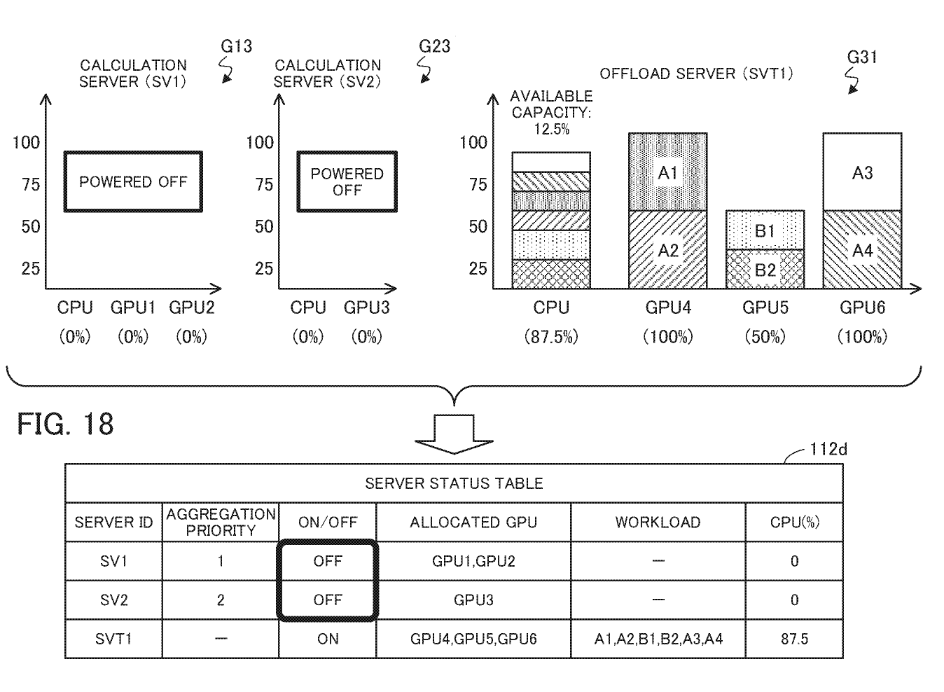

FIG. 18 is a diagram illustrating an example of the server status table obtained after the calculation servers are powered off. Graphs G13 and G23 indicate the CPU usages of the calculation servers 400 and 400a and the corresponding GPU usages after the calculation servers 400 and 400a are powered off. A graph G31 indicates the CPU usage of the offload server 400t and the corresponding GPU usages after the calculation servers 400 and 400a are powered off.

A server status table 112d indicates the statuses of the calculation servers 400 and 400a and the offload server 400t corresponding to the graphs G13, G23, and G31. The server control unit 143 changes the field under “ON/OFF” of each of the records of the calculation servers 400 and 400ato “OFF” indicating power-off.

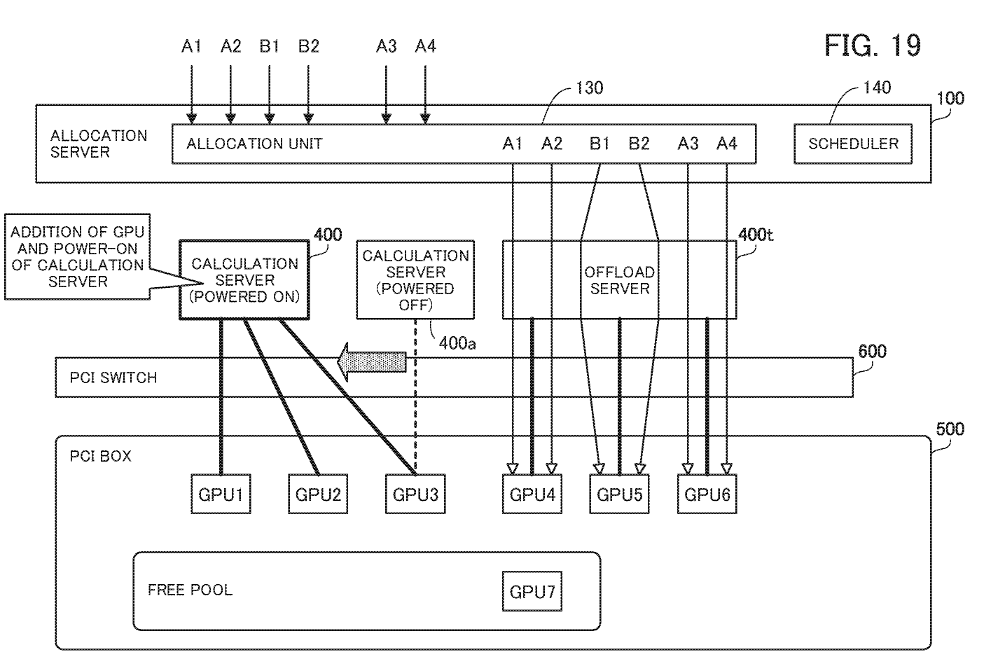

FIG. 19 is a diagram illustrating an example in which a GPU is added to a calculation server and the calculation server is powered on. The server control unit 143 instructs the PCI switch 600 to connect the GPU3 to the calculation server 400 via the management server 300. In response to the instruction, the connection destination of the GPU3 is changed from the calculation server 400a to the calculation server 400 by the PCI switch 600. Next, the server control unit 143 powers on the calculation server 400. During this process of adding the GPU to the calculation server 400 and powering on the calculation server 400, the workloads A1 to A4, B1, and B2 are continuously processed by the offload server 400t.

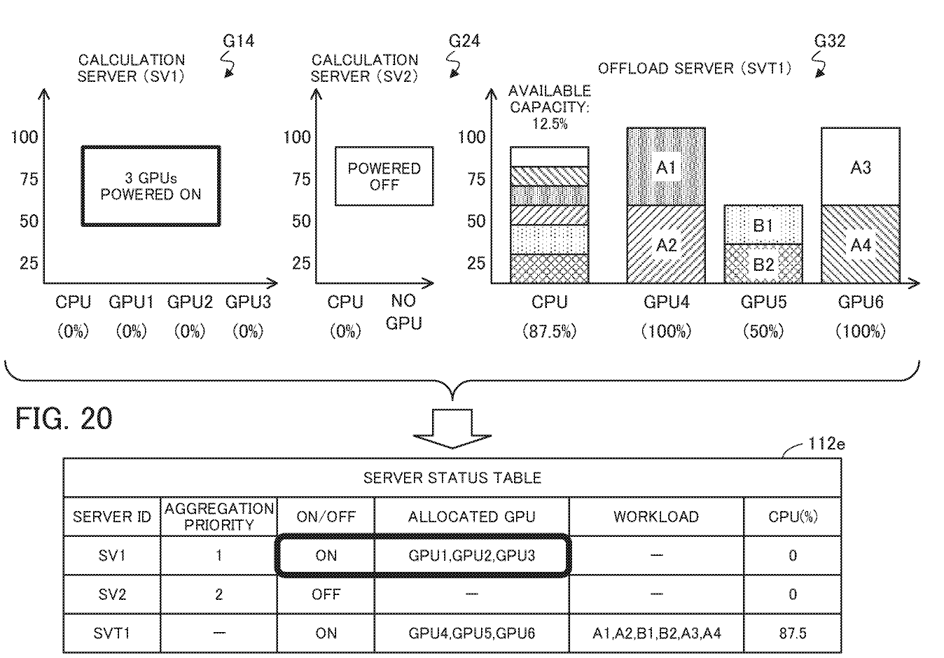

FIG. 20 is a diagram illustrating an example of the server status table obtained after the calculation server is powered on. A graph G14 indicates the CPU usage of the calculation server 400 and the corresponding GPU usages after the calculation server 400 is powered on. The number of GPUs connected to the calculation server 400 is three. A graph G24 indicates the CPU usage of the calculation server 400a. The calculation server 400ais powered off. The calculation server 400ais not connected to any GPU. A graph G32 indicates the CPU usage of the offload server 400t and the corresponding GPU usages after the calculation server 400 is powered on.

A server status table 112e indicates the statuses of the calculation servers 400 and 400a and the offload server 400t corresponding to the graphs G14, G24, and G32. The server control unit 143 changes the field under “ON/OFF” of the record of the calculation server 400 to “ON” indicating power-on.

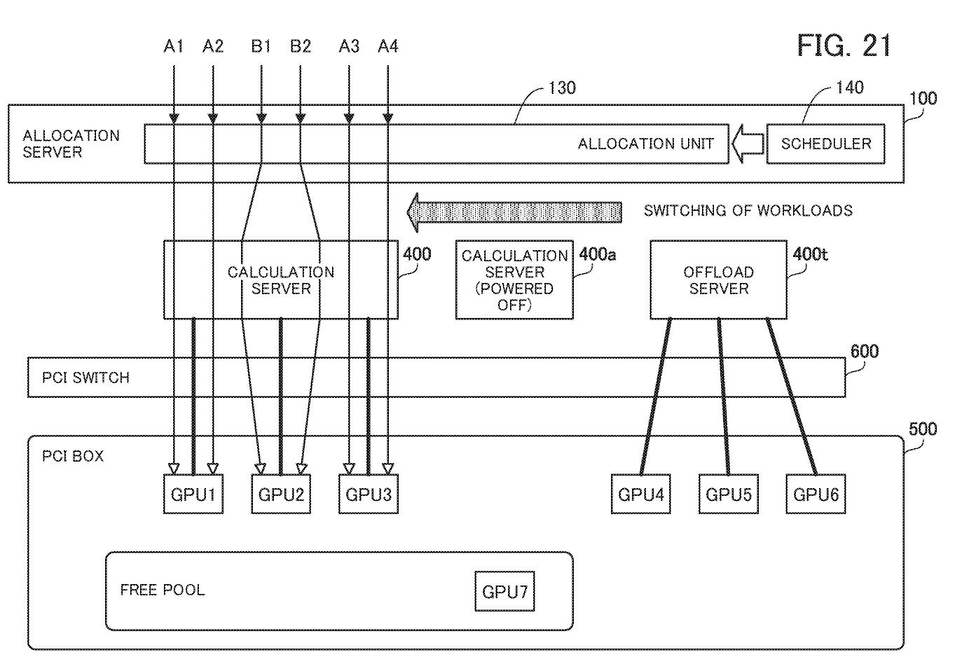

FIG. 21 is a diagram illustrating an example in which workloads are switched to a calculation server. After the activation of the calculation server 400, the server control unit 143 outputs an allocation instruction to the allocation unit 130 to switch the allocation destination of the workloads. Specifically, the server control unit 143 outputs an allocation instruction to the allocation unit 130 to change the allocation destination of the workloads A1 to A4, B1, and B2 from the offload server 400t to the calculation server 400.

The allocation unit 130 changes the allocation destination of the workloads A1 to A4, B1, and B2 from the offload server 400t to the calculation server 400 based on the allocation instruction. As a result, the workloads A1 to A4, B1, and B2 are transmitted to the calculation server 400 and are processed by the calculation server 400. The offload server 400twill no longer receive these workloads.

The calculation server 400 offloads the processing of the workloads A1 to A4, B1, and B2 to the GPU1 to GPU3. Specifically, the calculation server 400 offloads the processing of the workloads A1 and A2 to the GPU1. The calculation server 400 offloads the processing of the workloads B1 and B2 to the GPU2. The calculation server 400 offloads the processing of the workloads A3 and A4 to the GPU3.

The allocation unit 130 or the server control unit 143 may instruct the calculation server 400 about the offload destination GPU, for each workload. For example, the offload destinations are specified such that the workloads are mapped in the same way as those with the GPU4 to GPU6 prior to the switching. Specifically, the offload destinations are specified such that the workloads A1 and A2 processed by the GPU4 are offloaded to the GPU1, the workloads B1 and B2 processed by the GPU5 are offloaded to the GPU2, and the workloads A3 and A4 processed by the GPU6 are offloaded to the GPU3.

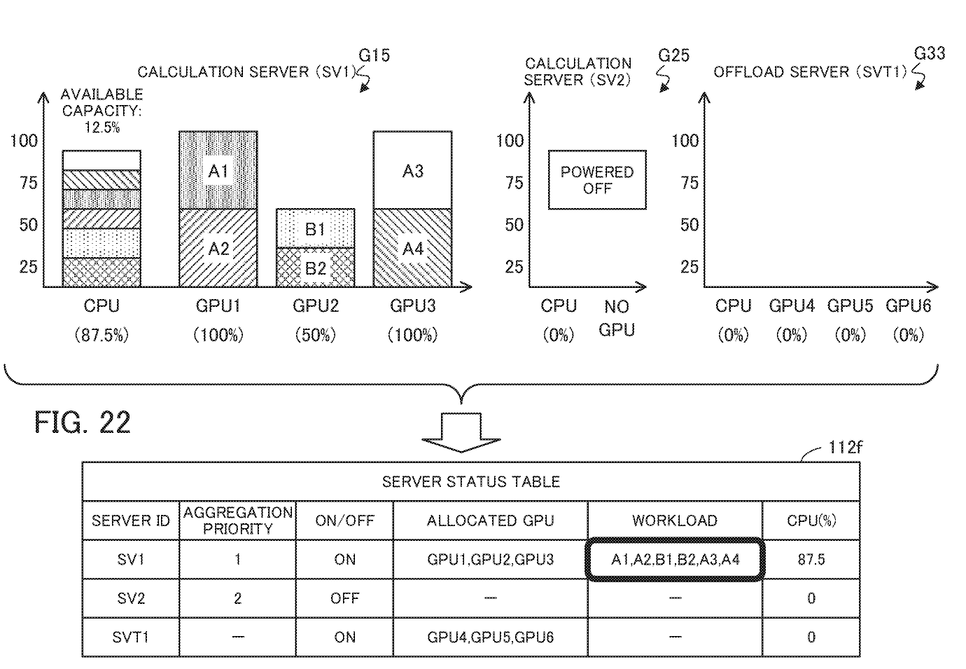

FIG. 22 is a diagram illustrating an example of the server status table obtained after the workloads are switched. A graph G15 indicates the CPU usage of the calculation server 400 and the corresponding GPU usages after the workloads are switched to the calculation server 400. A graph G25 indicates the CPU usage of the calculation server 400a and the corresponding GPU usage. The calculation server 400ais powered off. A graph G33 indicates the CPU usage of the offload server 400t and the corresponding GPU usage after the workloads are switched to the calculation server 400.

A server status table 112f indicates the statuses of the calculation servers 400 and 400a and the offload server 400t corresponding to the graphs G15, G25, and G33. The CPU usage of the calculation server 400 is 87.5%. Since the offload server 400tno longer receives the workloads, each of the CPU usage and the GPU usages is 0% or substantially 0%.

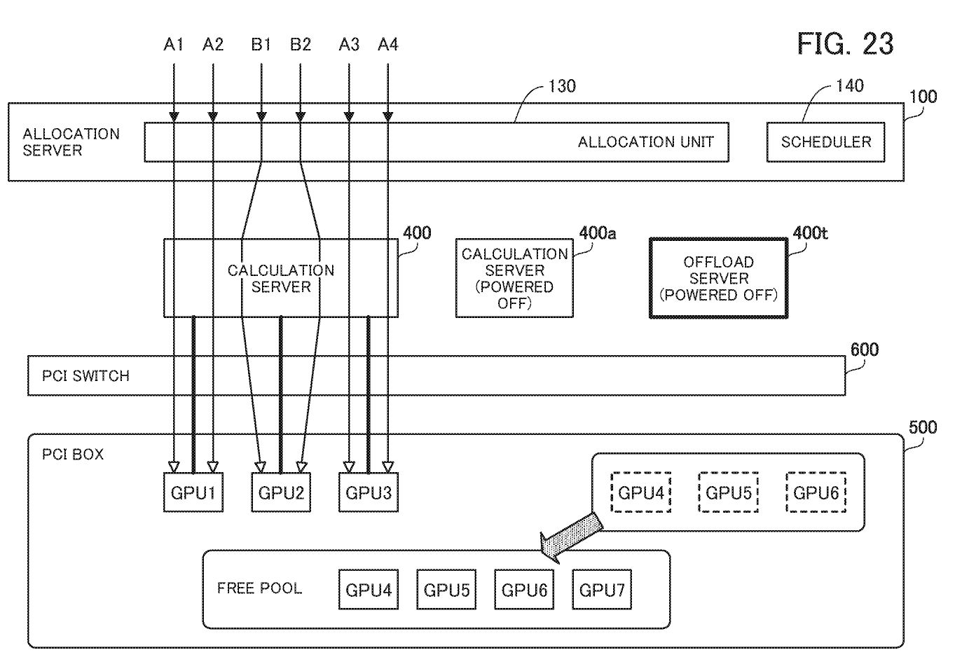

FIG. 23 is a diagram illustrating an example in which the offload server is powered-off. After the allocation destination of the workloads A1 to A4, B1, and B2 is changed to the calculation server 400, the server control unit 143 powers off the offload server 400t. The server control unit 143 instructs the PCI switch 600 to disconnect the offload server 400t from the GPU4 to GPU6 via the management server 300. As a result, the GPU4 to GPU6 are returned to the free pool. The instruction to power off the offload server 400tand to disconnect the offload server 400t from the GPU4 to GPU6 may be output by the offload server preparation unit 142.

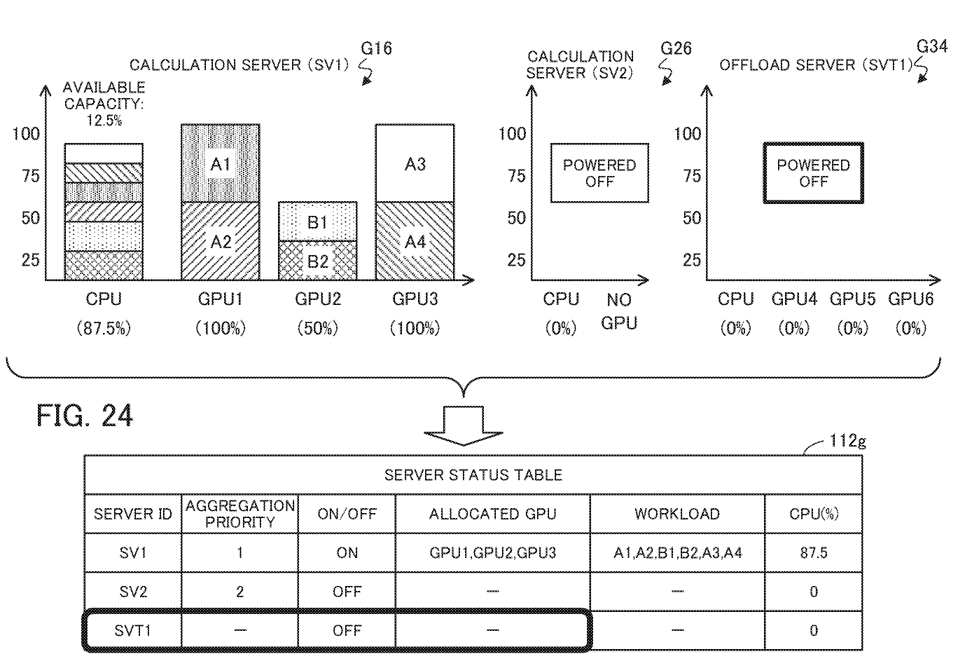

FIG. 24 is a diagram illustrating an example of the server status table obtained after the offload server is powered off. A graph G16 indicates the CPU usage of the calculation server 400 and the corresponding GPU usages after the workloads are switched to the calculation server 400. A graph G26 indicates the CPU usage of the calculation server 400a and the corresponding GPU usage. The calculation server 400ais powered off. A graph G34 indicates the CPU usage of the offload server 400t and the corresponding GPU usages after the workloads are switched to the calculation server 400. The offload server 400t is powered off.

A server status table 112g indicates the statuses of the calculation servers 400 and 400a and the offload server 400t corresponding to the graphs G16, G26, and G34. The CPU usage of the calculation server 400 is 87.5%. The calculation server 400aand the offload server 400t are powered off. After the offload server 400tis powered off, the GPU4 to the GPU6 are deallocated from the offload server 400t.

Thus, the workloads A1 to A4, B1, and B2 are continuously processed by the calculation server 400. In this way, the workloads A1 to A4, B1, and B2, which have been processed by the calculation servers 400 and 400a in a distributed manner, are aggregated in the calculation server 400.

Thereafter, the workloads A1 to A4, B1, and B2 are processed by the aggregation destination calculation server 400. There is a possibility that the load on the calculation server 400 will be relatively high depending on the workload occurrence status. Therefore, the allocation server 100 may monitor the load of the calculation server 400 and may reallocate the workloads A1 to A4, B1, and B2 to two or more calculation servers again, depending on the load of the calculation server 400.

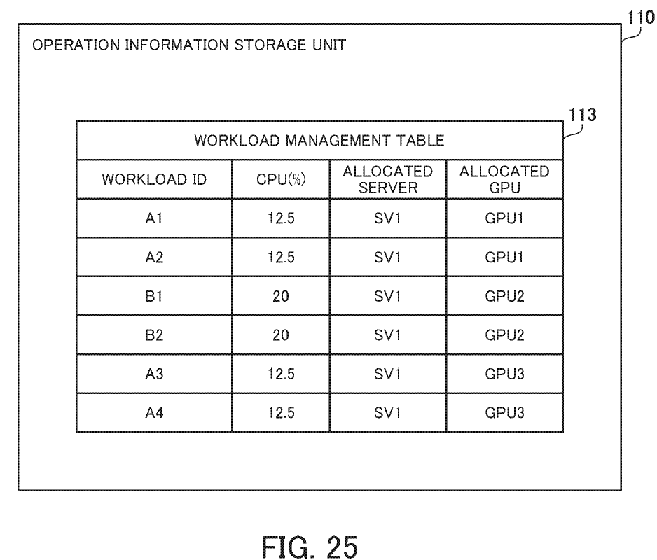

FIG. 25 is a diagram illustrating an example of a workload management table. This workload management table 113 is used for managing workloads. The workload management table 113 is generated by the operation information collection unit 120 and is stored in the operation information storage unit 110. The workload management table 113 includes fields under “workload ID”, “CPU(%)”, “allocated server”, and “allocated GPU”.

In a field under “workload ID”, identification information of a workload is registered. In a field under “CPU(%)”, a CPU usage corresponding to a workload is registered. In a field under “allocated server”, identification information of a calculation server to which a workload has been allocated is registered. In a field under “allocated GPU”, identification information of a GPU allocated to a calculation server is registered.

For example, the workload management table 113 has a record including “A1” under “workload ID”, “12.5” under “CPU(%)”, “SV1” under “allocated server”, and “GPU1” under “allocated GPU”. The record indicates that the allocation destination of the workload A1 is the calculation server 400, the CPU usage used by the processing of the workload A1 is 12.5%, and the offload destination of the processing of the workload A1 is the GPU1. In the example of the workload management table 113, the CPU usage of the calculation server 400 is the sum (= 90%) of the CPU usages for the workloads A1 to A4, B1, and B2.

For example, the scheduler 140 determines, based on the workload management table 113, whether the average value of the CPU usage of the calculation server 400 for a certain period of time is larger than a threshold. The scheduler 140 determines to reallocate the workloads A1 to A4, B1, and B2 when the average value of the CPU usage of the calculation server 400 for a certain period is larger than the threshold. The threshold such as 85% or 90% used for the reallocation determination is determined in advance.

Alternatively, the scheduler 140 may determine, based on the workload management table 113, whether a state in which the CPU usage of the calculation server 400 is larger than a threshold has continued for a certain period of time. The scheduler 140 may determine to reallocate the workloads A1 to A4, B1, and B2 when the state in which the CPU usage of the calculation server 400 is larger than a threshold has continued for a certain period of time.

Here, it is assumed that the scheduler 140 determines to reallocate the workloads A1 to A4, B1, and B2 based on the comparison between the CPU usage and a threshold based on the workload management table 113. For example, the scheduler 140 determines to allocate the workloads A3 and A4 of the GPU3 at the end of the workload management table 113 to another calculation server. The scheduler 140 may continuously select workloads to be allocated to other calculation servers until the CPU usage of the calculation server 400 becomes smaller than the threshold.

The scheduler 140 prepares the offload server 400t as in the case of the workload aggregation. Here, the scheduler 140 determines the number of GPUs to be connected to the offload server 400t based on the number of GPUs of the offload source calculation server 400. In one example, the scheduler 140 sets the number of GPUs to be connected to the offload server 400t to be the same as the number of GPUs of the offload source calculation server 400. In this case, three GPUs are connected to the offload server 400t, and the offload server 400t is powered on. However, the number of GPUs to be connected to the offload server 400t may be different from the number of GPUs of the offload-source calculation server 400. For example, the number of GPUs to be connected to the offload server 400t may be larger than the number of GPUs of the offload source calculation server 400. The scheduler 140 offloads the workloads A1 to A4, B1, and B2 of the calculation server 400 to the offload server 400t. The offload server to be newly set as the offload destination may be a server other than the offload server 400t.

The scheduler 140 powers off the calculation server 400, disconnects the calculation server 400 from the GPU3, and connects the GPU3 to the calculation server 400a. The calculation server to be newly set as the distribution destination may be a server other than the calculation server 400a. In addition, the scheduler 140 determines the number of GPUs whose connection destination is changed to the calculation server 400a according to the workloads to be transferred. In this example, since the transfer target workloads A3 and A4 have been offloaded to the GPU3 by the calculation server 400, the connection destination of the GPU3 is changed to the calculation server 400a.

The scheduler 140 powers on the calculation servers 400 and 400a. Then, the scheduler 140 changes the allocation destination of the workloads A3 and A4 to the calculation server 400a. The scheduler 140 powers off the offload server 400tand returns the GPU connected to the offload server 400t to the free pool. As a result, the workloads A1, A2, B1, and B2 are processed by the calculation server 400. The workloads A3 and A4 are processed by the calculation server 400a.

In this way, the information processing system 50 is able to perform control such that the workloads A1 to A4, B1, and B2 are processed by the calculation servers 400 and 400a in a distributed manner again. The information processing system 50 is able to suppress concentration of the load of the workload processing on the calculation server 400, and is able to speed up the workload processing.

As described above, the information processing system 50 is able to prevent interruption of the workload processing due to GPU reallocation associated with workload aggregation or distribution. When reallocating GPUs between calculation servers, the information processing system 50 temporarily offloads workloads to an offload server, and reallocates the GPUs to an offload source calculation server and restarts the offload source calculation server. Thus, in the information processing system 50, the offload server is able to process the workloads during reallocation and restart of the GPUs, and it is possible to prevent interruption of the workload processing. For example, the information processing system 50 may interrupt the processing of the workloads to such an extent that the user is unaware of the interruption, or to such an extent that is virtually no interruption.

In addition, the information processing system 50 is able to improve the operating rate of the entire system and to reduce the power consumption by reallocating the GPUs without interrupting the workload processing. Further, for example, the information processing system 50 is able to minimize the number of calculation servers used for operation, and is able to efficiently use the resources of the calculation servers 400, 400a, etc.

Here, the information processing system 50 may include accelerators other than GPUs. The workloads may be data other than streaming data, such as an image or audio. For example, the information processing system 50 may include a plurality of accelerators for cryptographic processing. In this case, the workloads may be plaintext data to be encrypted or encrypted data to be decrypted.

In the example according to the second embodiment, the information processing system 50 uses the offload server 400t as a temporary offload destination, and causes the calculation server 400 to execute the workload processing again. However, the workload processing does not need to be executed by the calculation server 400 again. That is, the information processing system 50 may continuously use the offload server 400tfor the actual workload processing, instead of the calculation server 400. In this case, the information processing system 50 performs additional management processing such as managing the calculation server 400 or another calculation server as a new spare machine. When the information processing system 50 causes the calculation server 400 to execute the workload processing again, the information processing system 50 does not need to perform the additional management processing.

The information processing according to the first embodiment may be implemented by causing the processor 32 to execute a program. The information processing according to the second embodiment may be implemented by causing the CPU 101 to execute a program. The program may be recorded in the computer-readable recording medium 73.

For example, the program may be distributed by distributing the recording medium 73 on which the program is recorded. The program may be stored in another computer and distributed via a network. For example, a computer may store (install) the program recorded in the recording medium 73 or the program received from another computer in a storage device such as the RAM 102 or the HDD 103, may read the program from the storage device, and may execute the program.

In one aspect, interruption of processing is prevented.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A workload aggregation system comprising:
a plurality of information processing apparatuses, each of which has a processor;
a plurality of accelerators which are connectable to the plurality of information processing apparatuses and are used for processing a workload received by a connection destination information processing apparatus; and
a control apparatus which
detects that a plurality of workloads processed by a first information processing apparatus and a second information processing apparatus among the plurality of information processing apparatuses, the first information processing apparatus being connected to a first accelerator among the plurality of accelerators, and the second information processing apparatus being connected to a second accelerator among the plurality of accelerators, are aggregatable into one information processing apparatus, based on a load of the processor of each of the plurality of information processing apparatuses,
prepares a third information processing apparatus to which an accelerator different from the first accelerator and the second accelerator among the plurality of accelerators is connected,
changes the transmission destination of the plurality of workloads to the third information processing apparatus,
powers off the first information processing apparatus and the second information processing apparatus,
changes the connection destination of the second accelerator to the first information processing apparatus,
powers on the first information processing apparatus, and
changes the transmission destination of the plurality of workloads to the first information processing apparatus.

2. The workload aggregation system according to claim 1, wherein in the preparing of the third information processing apparatus, the control apparatus
determines a number of accelerators to be connected to the third information processing apparatus based on a number of accelerators connected to the first information processing apparatus and the second information processing apparatus,
connects the determined number of accelerators to the third information processing apparatus that is powered off, and
powers on the third information processing apparatus.

3. The workload aggregation system according to claim 1, wherein after changing the transmission destination of the plurality of workloads from the third information processing apparatus to the first information processing apparatus, the control apparatus powers off the third information processing apparatus and disconnects the accelerator connected to the third information processing apparatus from the third information processing apparatus.

4. The workload aggregation system according to claim 1, wherein in the detecting that a plurality of workloads are aggregatable, the control apparatus compares a sum of a load of a first processor included in the first information processing apparatus and a load of a second processor included in the second information processing apparatus with a first threshold, and determines that the plurality of workloads processed by the first information processing apparatus and the second information processing apparatus are aggregatable into one information processing apparatus upon detecting that the sum is smaller than the first threshold.

5. The workload aggregation system according to claim 1, wherein upon detecting that a load of a first processor included in the first information processing apparatus is larger than a second threshold after the control apparatus changes the transmission destination of the plurality of workloads to the first information processing apparatus, the control apparatus
prepares a fourth information processing apparatus to which an accelerator different from the first accelerator and the second accelerator among the plurality of accelerators is connected,
changes the transmission destination of the plurality of workloads to the fourth information processing apparatus, powers off the first information processing apparatus,
changes the connection destination of the first accelerator or the second accelerator to a fifth information processing apparatus among the plurality of information processing apparatuses,
powers on the first information processing apparatus and the fifth information processing apparatus,
changes a transmission destination of a first workload among the plurality of workloads to the first information processing apparatus, and
changes a transmission destination of a second workload among the plurality of workloads to the fifth information processing apparatus.

6. A non-transitory computer-readable recording medium storing therein a computer program that causes a computer to execute a process comprising:
detecting that a plurality of workloads processed by a first information processing apparatus and a second information processing apparatus among a plurality of information processing apparatuses, the first information processing apparatus being connected to a first accelerator among a plurality of accelerators used for processing a workload, and the second information processing apparatus being connected to a second accelerator among the plurality of accelerators, are aggregatable into one information processing apparatus, based on a load of a processor of each of the plurality of information processing apparatuses,
preparing a third information processing apparatus to which an accelerator different from the first accelerator and the second accelerator among the plurality of accelerators is connected,
changing the transmission destination of the plurality of workloads to the third information processing apparatus,
powering off the first information processing apparatus and the second information processing apparatus,
changing the connection destination of the second accelerator to the first information processing apparatus,
powering on the first information processing apparatus, and
changing the transmission destination of the plurality of workloads to the first information processing apparatus.

7. A workload aggregation system comprising:
a plurality of information processing apparatuses, each of which has a processor;
a plurality of accelerators which are connectable to the plurality of information processing apparatuses and are used for processing a workload received by a connection destination information processing apparatus; and
a control apparatus which
detects that a plurality of workloads processed by a first information processing apparatus and a second information processing apparatus among the plurality of information processing apparatuses, the first information processing apparatus being connected to a first accelerator among the plurality of accelerators, and the second information processing apparatus being connected to a second accelerator among the plurality of accelerators, are aggregatable into one information processing apparatus, based on a load of the processor of each of the plurality of information processing apparatuses,
connects a third accelerator and a fourth accelerator among the plurality of accelerators to a third information processing apparatus that is powered off,
powers on the third information processing apparatus, and
changes the transmission destination of the plurality of workloads to the third information processing apparatus.

8. The workload aggregation system according to claim 7, wherein the control apparatus determines a number of accelerators to be connected to the third information processing apparatus based on a number of accelerators connected to the first information processing apparatus and the second information processing apparatus.

9. The workload aggregation system according to claim 7, wherein after changing the transmission destination of the plurality of workloads to the third information processing apparatus, the control apparatus powers off the first information processing apparatus and the second information processing apparatus, disconnects the first accelerator from the first information processing apparatus, and disconnects the second accelerator from the second information processing apparatus.

10. The workload aggregation system according to claim 7, wherein in the detecting that the plurality of workloads are aggregatable, the control apparatus compares a sum of a load of a first processor included in the first information processing apparatus and a load of a second processor included in the second information processing apparatus with a first threshold, and determines that the plurality of workloads processed by the first information processing apparatus and the second information processing apparatus are aggregatable into one information processing apparatus upon detecting that the sum is smaller than the first threshold.

11. A non-transitory computer-readable recording medium storing therein a computer program that causes a computer to execute a process comprising:
detecting that a plurality of workloads processed by a first information processing apparatus and a second information processing apparatus among a plurality of information processing apparatuses, the first information processing apparatus being connected to a first accelerator among a plurality of accelerators used for processing a workload, and the second information processing apparatus being connected to a second accelerator among the plurality of accelerators, are aggregatable into one information processing apparatus, based on a load of a processor of each of the plurality of information processing apparatuses,
connecting a third accelerator and a fourth accelerator among the plurality of accelerators to a third information processing apparatus that is powered off,
powering on the third information processing apparatus, and
changing the transmission destination of the plurality of workloads to the third information processing apparatus.
